(19) United States
(12) Patent Application Publication
(10) Pub. No.: US 2025/0330619 A1
(43) Pub. Date: Oct. 23, 2025

(54) CROSS-COMPONENT PREDICTION AND GEOMETRIC PARTITION WEIGHT ADAPTION IN GEOMETRIC PARTITION MODE

(71) Applicant: Tencent America LLC, Palo Alto, CA (US)

(72) Inventors: Lien-Fei CHEN, Palo Alto, CA (US); Biao WANG, San Jose, CA (US); Yonguk YOON, Palo Alto, CA (US); Roman CHERNYAK, Santa Clara, CA (US); Motong XU, Palo Alto, CA (US); Yifan WANG, Palo Alto, CA (US); Ziyue XIANG, Palo Alto, CA (US); Shan LIU, San Jose, CA (US); Tianqi LIU, Palo Alto, CA (US)

(73) Assignee: Tencent America LLC, Palo Alto, CA (US)

(21) Appl. No.: 19/182,375

(22) Filed: Apr. 17, 2025

Related U.S. Application Data
(60) Provisional application No. 63/635,974, filed on Apr. 18, 2024.
(60) Provisional application No. 63/636,780, filed on Apr. 20, 2024.
(60) Provisional application No. 63/638,394, filed on Apr. 24, 2024.

(51) Int. Cl. H04N 19/176; G06V 10/75; H04N 19/117; H04N 19/139; H04N 19/186; H04N 19/80

(52) U.S. Cl. CPC H04N 19/176; G06V 10/751; H04N 19/117; H04N 19/139; H04N 19/186; H04N 19/80

(57) ABSTRACT

Methods and apparatuses for video decoding and video encoding and methods of processing visual media data are provided. A method for video decoding includes receiving coded information indicating that a current block is coded with a geometric partition mode (GPM) with multiple blending width sets, determining a blending width set from the multiple blending width sets to be applied to the current block based on block size information and GPM information of the current block, determining a blending width from the determined blending width set, and reconstructing the current block according to the GPM and the determined blending width.

### RELATED APPLICATIONS

The present application claims the benefit of priority to U.S. Provisional Application No. 63/635,974, “CROSS-COMPONENT PREDICTION IN GEOMETRIC PARTITION MODE FOR CHROMA BLOCK” filed on Apr. 18, 2024, U.S. Provisional Application No. 63/636,780, “GEOMETRIC PARTITION WEIGHT ADAPTION BASED ON GEOMETRIC PARTITION MODE INFORMATION AND BLOCK INFORMATION” filed on Apr. 20, 2024, and U.S. Provisional Application No. 63/638,394, “AFFINE MOTION VECTOR PREDICTOR AND MERGE CANDIDATE CONSTRUCTION BY USING INTRA TEMPLATE-MATCHING” filed on Apr. 24, 2024, which are incorporated by reference herein in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure include methods and apparatuses for video encoding/decoding.

Aspects of the disclosure provide a method for video decoding in which coded information indicating that a current block is coded with a geometric partition mode (GPM) with multiple blending width sets is received. A blending width set from the multiple blending width sets to be applied to the current block is determined based on block size information and GPM information of the current block. A blending width from the determined blending width set is determined. The current block is reconstructed according to the GPM and the determined blending width.

Aspects of the disclosure also provide a method for video decoding in which coded information is received. The coded information indicates that a chroma block is coded based on a corresponding luma block using a cross-component prediction and a multi-model filter where the luma block is predicted by a geometric partition mode (GPM) and includes a first partition and a second partition separated by a geometric split edge of the GPM. The multi-model filter for the chroma block is determined. The chroma block includes a first partition and a second partition separated by a geometric split edge. The multi-model filter includes one of (i) first filter coefficients determined based on the first partition of the luma block and the first partition of the chroma block and second filter coefficients determined based on the second partition of the luma block and the second partition of the chroma block and (ii) the first filter coefficients determined based on a first luma template of the luma block and a first chroma template of the chroma block and the second filter coefficients determined based on a second luma template of the luma block and a second chroma template of the chroma block. A luma template of the luma block is adjacent to the luma block and includes reconstructed luma samples. The luma template includes the first luma template and the second luma template separated by an extension of the geometric split edge into the luma template. A chroma template of the chroma block is adjacent to the chroma block and includes reconstructed chroma samples. The chroma template includes the first chroma template and the second chroma template separated by an extension of the geometric split edge into the chroma template. The method for video decoding includes reconstructing the chroma block according to the multi-model filter.

Aspects of the disclosure also provide a method for video decoding in which coded information indicating that a current block in a current picture is coded with an affine mode is received. A template-matching process is applied to determine a reference block in the current picture. Control point motion vectors (CPMVs) of the current block are determined based on motion vector information associated with a plurality of corners of the reference block. The current block is reconstructed based on the determined CPMVs of the current block.

Aspects of the disclosure also provide an apparatus for video decoding. The apparatus for video decoding includes processing circuitry configured to implement any of the described methods for video decoding.

Aspects of the disclosure also provide a method for video encoding in which a blending width set is determined from multiple blending width sets to be applied to a current block based on block size information and GPM information of the current block. A blending width is determined from the determined blending width set, and the current block is encoded according to the GPM and the determined blending width.

Aspects of the disclosure also provide a method for video encoding in which a multi-model filter for a chroma block is determined. The chroma block includes a first partition and a second partition separated by a geometric split edge. The chroma block is encoded based on a corresponding luma block using a cross-component prediction and the multi-model filter, and the luma block is predicted by the GPM and includes a first partition and a second partition separated by a geometric split edge of the GPM. The multi-model filter includes one of (i) first filter coefficients determined based on the first partition of the luma block and the first partition of the chroma block and second filter coefficients determined based on the second partition of the luma block and the second partition of the chroma block and (ii) the first filter coefficients determined based on a first luma template of the luma block and a first chroma template of the chroma block and the second filter coefficients determined based on a second luma template of the luma block and a second chroma template of the chroma block. A luma template of the luma block is adjacent to the luma block and includes reconstructed luma samples. The luma template includes the first luma template and the second luma template separated by an extension of the geometric split edge into the luma template. A chroma template of the chroma block is adjacent to the chroma block and includes reconstructed chroma samples. The chroma template includes the first chroma template and the second chroma template separated by an extension of the geometric split edge into the chroma template. The method for video encoding includes encoding the chroma block according to the multi-model filter.

Aspects of the disclosure also provide a method for video encoding in which a template-matching process is applied to determine a reference block in a current picture for a current block in the current picture. Control point motion vectors (CPMVs) of the current block are determined based on motion vector information associated with a plurality of corners of the reference block. The current block is encoded based on the determined CPMVs of the current block with an affine mode.

Aspects of the disclosure also provide an apparatus for video encoding. The apparatus for video encoding includes processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4A shows an example of a geometric partition mode (GPM) applied to a block according to an aspect of the disclosure.

FIG. 4B shows a predefined number of angles distributed from 0° to 360° for a GPM according to an aspect of the disclosure.

FIG. 4C shows multiple partition edges corresponding to an angle for a GPM according to an embodiment of the disclosure.

FIG. 4D shows an example of a GPM blending process applied to a current block according to an embodiment of the disclosure.

FIG. 5 shows an example of a cross-component prediction according to an aspect of the disclosure.

FIG. 6 shows an example of a cross-component prediction on a geometric partition block according to an aspect of the disclosure.

FIG. 7 shows an example of a cross-component prediction on a geometric partition block according to an aspect of the disclosure.

FIG. 8 shows an example of a bilateral matching (BM)-based decoder side motion vector refinement (DMVR) according to an aspect of the disclosure.

FIG. 9A shows an affine motion field of a block (902) described by motion information of two control points (4-parameter) according to an aspect of the disclosure.

FIG. 9B shows an affine motion field of a block (904) described by three control point motion vectors (6-parameter) according to an aspect of the disclosure.

FIGS. 10-11 show an example of an affine model by using template-matching (TM) in a coded region in a current picture according to an aspect of the disclosure.

FIG. 12 shows an example of control point motion vector (CPMV) derivation for a current block based on motion information at corners of a reference block according to an aspect of the disclosure.

FIG. 13 shows a flow chart outlining a decoding process according to some aspects of the disclosure.

FIG. 14 shows a flow chart outlining a decoding process according to an aspect of the disclosure.

FIG. 15 shows a flow chart outlining a decoding process according to an aspect of the disclosure.

FIG. 16 is a schematic illustration of a computer system in accordance with an aspect.

### DETAILED DESCRIPTION

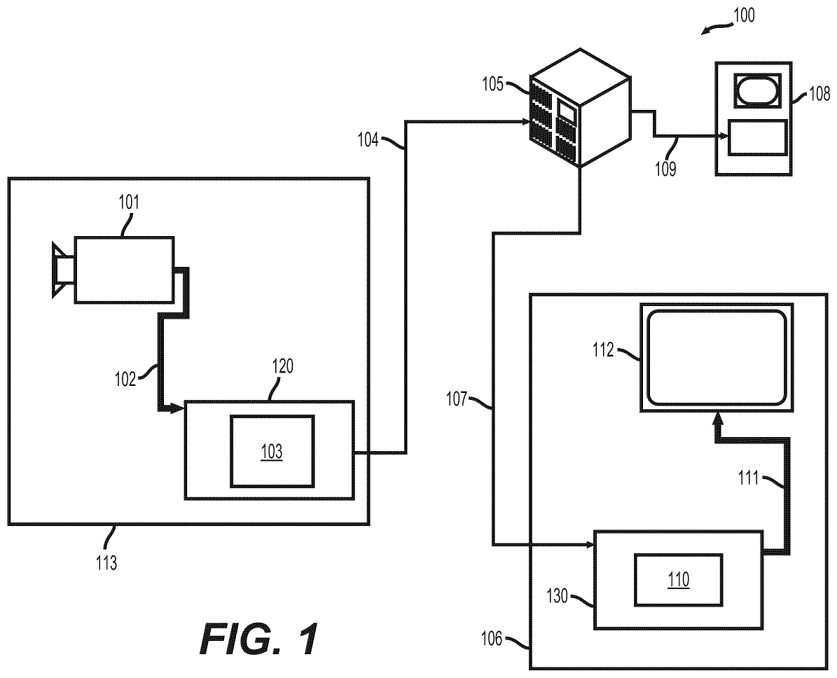

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

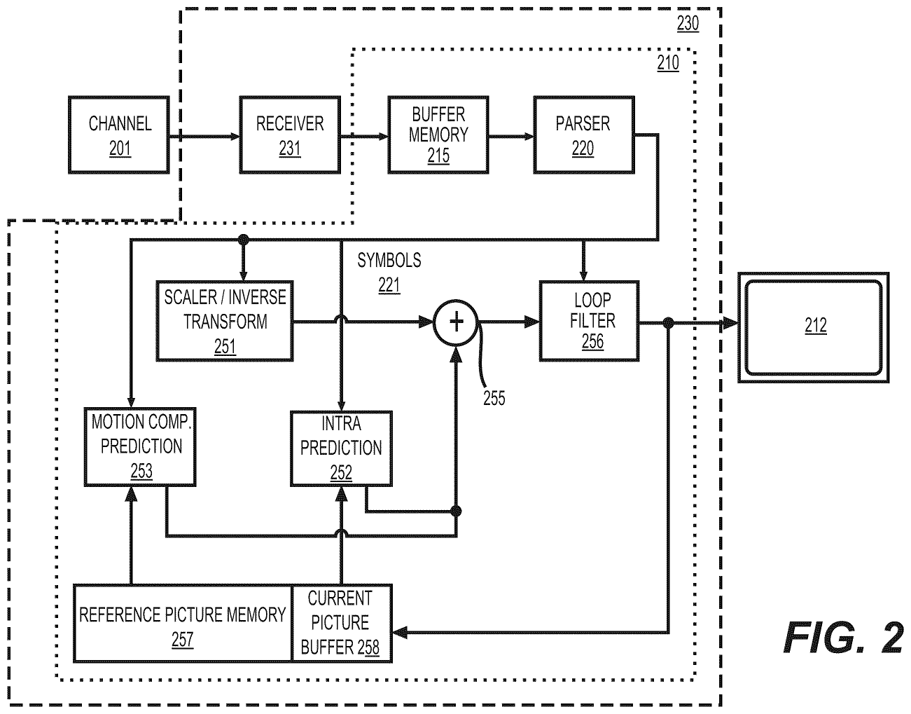

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decodeτ/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, partly, be integrated into each other. However, for the purpose of describing the disclosed subject matter, the conceptual subdivision into the functional units below is appropriate.

A first unit is the scaleτ/inverse transform unit (251). The scaleτ/inverse transform unit (251) receives a quantized transform coefficient as well as control information, including which transform to use, block size, quantization factor, quantization scaling matrices, etc. as symbol(s) (221) from the parser (220). The scaleτ/inverse transform unit (251) can output blocks comprising sample values, that can be input into aggregator (255).

In some cases, the output samples of the scaleτ/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaleτ/inverse transform unit (251).

In other cases, the output samples of the scaleτ/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaleτ/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

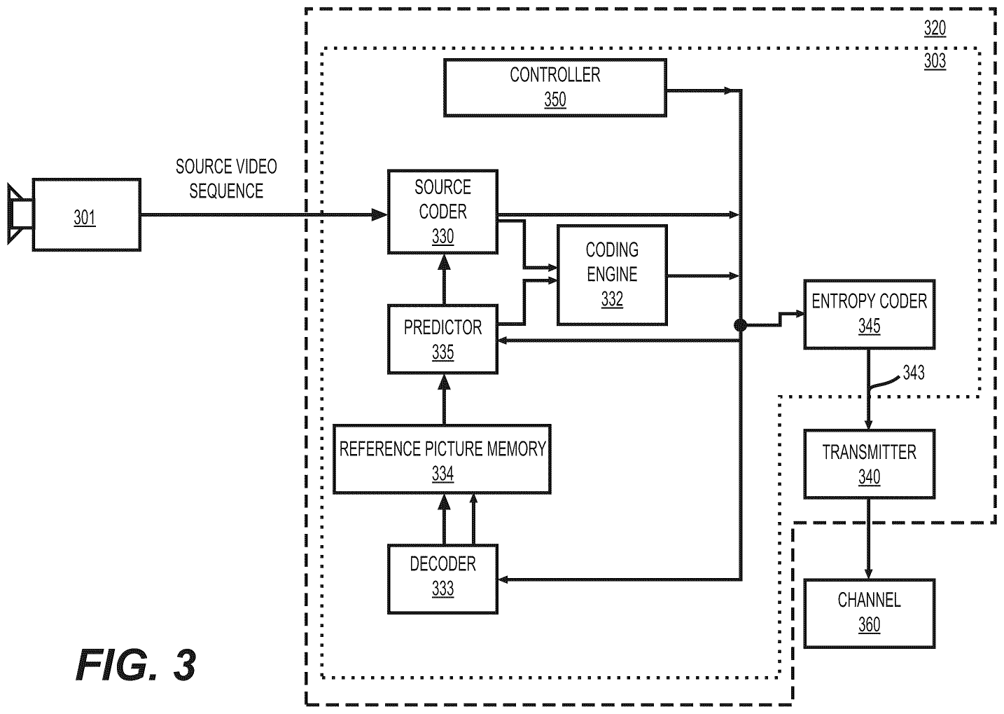

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Video coding has been widely used in many applications such as broadcasting, video recording, video streaming, and the like. Various emerging video coding standards such as H.264, H.265/HEVC, H.266/VVC, and AV1 are adopted in the video applications. A hybrid video codec can include coding modules, intra prediction, inter prediction, transform coding, quantization, entropy coding, post in-loop filters, and the like.

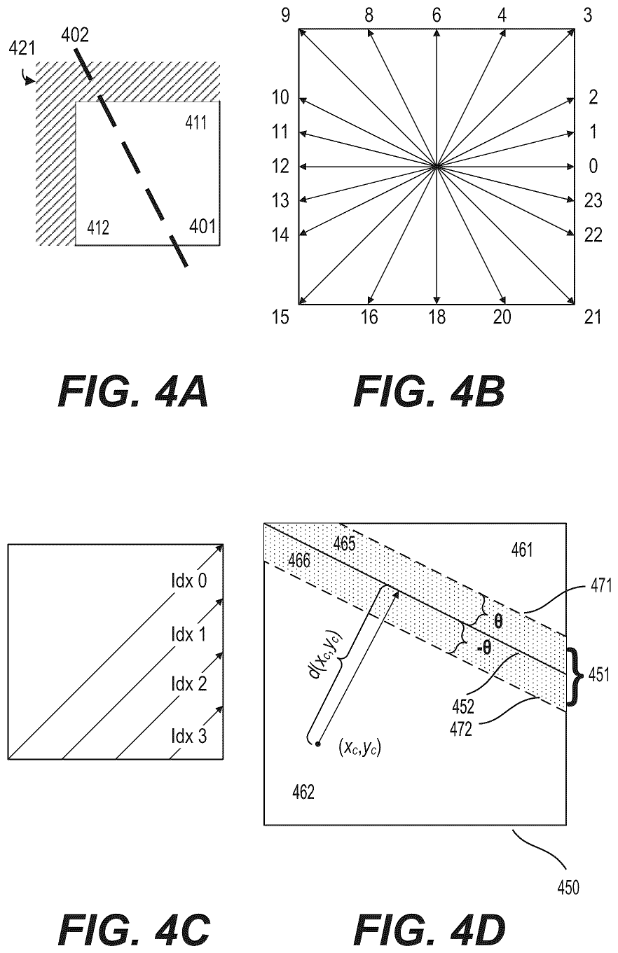

In an aspect, geometric partition prediction is a prediction mode with two different geometric partitions by using a geometric split edge. The geometric partition prediction can be referred to as geometric partition mode (GPM). FIG. 4A shows an example of the GPM applied to a block (401) according to an aspect of the disclosure. The block (401) can be partitioned into partitions (411)-(412) by a geometric split edge (402). Each partition can be coded in an intra prediction mode, an inter prediction mode, a block vector (BV) based prediction mode such as an intra block copy (IBC) mode, an intra template matching prediction (IntraTMP) mode, or the like. In the BV based prediction mode, a current block in a current picture is to be predicted. A reference block that is in an already reconstructed region in the current picture can be determined, and a BV can indicate (e.g., point to) the reference block from the current block. In an example, the geometric split edge (402) extends into a template (421) of the block (401). In an example, a combination of a partition mode and a combination of prediction modes (e.g., intra prediction modes) for the two partitions (411)-(412) can be signalled in a bitstream. In an example, three syntax can be signalled to indicate which partition mode and which prediction modes (e.g., intra prediction modes) are applied to the two partitions (411)-(412).

The GPM can be used for inter prediction, such as in VVC. In an example, the GPM is only applied to CUs that are 8×8 or larger. In an aspect, when the GPM is used, a CU can be split into two geometric-shaped partitions (also referred to as a geometric partition or a partition) by using one of a predefined number (e.g., 64) of different partitioning manners or GPM split modes. A geometric partition index (or a GPM split mode index) can be used to indicate a partitioning manner or a GPM split mode, such as one out of the 64 different partitioning manners. The different partitioning manners can be differentiated by a predefined number (e.g., 24) of angles (e.g., non-uniformed quantized between 0 and 360°) and up to a predefined number (e.g., 4) of partition edges (also referred to as geometric split edges) relative to a center of the CU, such as shown in FIGS. 4B-4C.

FIG. 4B shows a predefined number of angles (or multiple angles) distributed from 0° to 360°, such as 24 supported angles in VVC, according to an embodiment of the disclosure. The multiple angles can be indicated by respective angle indices 0-23. FIG. 4C shows multiple partition edges (e.g., 4 partition edges indicated by respective indices (idx) 0-3) corresponding to one of the multiple angles, such as supported possible partition edges for the angle index 3, according to an embodiment of the disclosure. A set of GPM split modes that is available to code a block can be based on a suitable combination of the multiple angles and the associated partition edge(s) shown in FIGS. 4B-4C.

In an embodiment, each geometric partition in the CU is inter-predicted using respective motion information. In an example, only uni-prediction is allowed for each partition, for example, each partition has a respective MV and a respective reference index. The uni-prediction motion constraint can be applied to ensure that only two motion compensated predictions are used for each CU which is the same when a bi-prediction is applied to the entire CU. In some examples, bi-prediction is applied to a partition in the CU.

In an embodiment, inter prediction and another prediction (e.g., intra prediction) are used for the geometric partitions in the CU.

If the GPM is used for a CU, information indicating a geometric partition index for the CU and prediction information of two geometric partitions in the CU can be signaled. In an example, the prediction information includes two merge indices if each geometric partition in the CU is inter-predicted. The prediction information can include a merge index and an index indicating an intra prediction mode if inter prediction and intra prediction are used for the geometric partitions in the CU.

After predicting the two geometric partitions, sample values in a blending region (including samples along the partition edge) can be adjusted using a blending process (or a GPM blending process) with adaptive weights. A size of the blending region can be indicated by a blending width 0 shown in FIG. 4C. The blending width 0 can be a width of the blending area measured perpendicular to the partition edge (452).

In an embodiment, the blending width 0 is fixed, for example, for CUs having different contents, such as natural contents, screen contents, a mixture of natural content(s) and screen content(s), and the like. In an embodiment, the blending width 0 is adaptive, for example, is selected from a blending width set (also referred to as a width candidate list).

FIG. 4C shows an exemplary GPM blending process applied to a CU (450) according to an embodiment of the disclosure. The CU (450) can be partitioned into geometric partitions (461)-(462) by a partition edge (452). In an example, a first prediction mode and a second prediction mode are applied to predict samples in the CU (450) as P0 and P1, respectively. The first prediction mode and the second prediction mode can include suitable prediction mode(s), such as inter prediction mode(s), an intra prediction mode, an IBC mode, an IntraTMP mode, and/or the like.

The partition edge (452) can be oriented at an angle that corresponds to an angle index (e.g., the angle index 10 or 22 in FIG. 4B). The partition edge (452) and the angle index can correspond to a geometric partition index of the CU (450).

A blending region or a blending area (451) can include samples along the partition edge (452). The blending region (451) can include samples that are within a distance (or the blending width) θ from the partition edge (452). Boundaries (471)-(472) of the blending region (451) are parallel to the partition edge (452) and are separated from the partition edge (452) by the distance θ. In an example, the blending region (451) include a first blending region (465) and a second blending region (466) that are separated by the partition edge (452). The first blending region (465) can be within the partitions (461) and the second blending region (466) can be within the partition (462).

A sample in the CU (450) can be determined based on the blending process, for example, as a weighted sum P.

$$P = ( 1 - W ) \times P 1 + W \times P 0 \qquad Eq . 1$$

P0 and P1 can represent prediction values of the sample based on the first prediction mode and the second prediction mode, respectively. A weight (W) can be determined for the sample in the CU (450) based on a displacement d(x_{c}, y_{c}) of the sample in the CU (450) from the partition edge (452).

A blending mask can be applied to the CU (450), and weights (or weighing values) ω_{xc,yc} in the blending mask can be given by a ramp function below. In an example, W is ω_{xc,yc}.

$${ω}_{{x}_{c} , {y}_{c}} = \{ \begin{matrix}0 & d ( {x}_{c} , {y}_{c} ) \leq - θ \\ \frac{8}{2 θ} d ( {x}_{c} , {y}_{c} ) + θ & - θ < d ( {x}_{c} , {y}_{c} ) < θ \\ 8 & d ( {x}_{c} , {y}_{c} ) \geq θ\end{matrix} \qquad Eq . 2$$

When the sample (x_{c}, y_{c}) is located in the partition (462) and outside the second blending region (466), the displacement d(x_{c}, y_{c}) is less than or equal to −θ, and ω_{xc,yc} and W is 0. Accordingly, the samples in the partition (462) that are outside the blending region (451) can be predicted as P1 based on the second prediction mode.

When the sample (x_{c}, y_{c}) is located in the partition (461) and outside the first blending region (465), the displacement d(x_{c}, y_{c}) is larger than or equal to θ, and ω_{xc,yc} is 8 and W is 1. Accordingly, the samples in the partition (461) that are outside the blending region (451) can be predicted as P0 based on the first prediction mode. In an example, no blending is used for the samples that are outside the blending region (451).

When the sample (x_{c}, y_{c}) is located in the blending region (451), the displacement d(x_{c}, y_{c}) is between −θ and θ, and ω_{xc,yc} is determined based on the displacement d(x_{c}, y_{c}), such as shown in Eq. 2. The samples in the blending region (451) can be predicted as the weighted sum of P0 and P1 as described in Eq. 1.

In an example, θ is fixed as 2 pixels (pel), such as in the current VVC design, the ramp function ω_{xc,yc} can be quantized as ω_{m,n}

$${ω}_{m , n} = Clip 3 ( ( 0 , 8 , ( d ( m , n ) + 32 + 4 ) ≫ 3 ) \qquad Eq . 3$$

In an example, d(m, n) is 16×d(x_{c}, y_{c}).

The blended results P (e.g., the predicted sample values the CU (450)) can include the prediction signal for the CU (450) (e.g., the entire CU (450)). A transform process and a quantization process can be applied to the CU (450) as in other prediction modes. The motion field of the CU (450) predicted using the GPM can be stored.

A partition mode in the GPM can indicate a geometric split edge and a geometric partition by using the geometric split edge. A blending width set including a plurality of blending widths can be used. An index can be signalled to indicate which blending width in the blending width set is used to blend two samples from two partitions within a blending region along the geometric split edge.

A blending width set can include any number of blending widths, such as 5 blending widths {θ1, θ2, θ3, θ4, θ5}. In an example, the blending width set includes {0, 1, 2, 4, 8}. In an example, the blending width set includes {τ/4, τ/2, τ, 2τ, 4τ}, where τ is a positive number. When τ is 2, the blending width set includes {½, 1, 2, 4, 8}.

According to an aspect of the disclosure, more than one blending width sets or multiple blending width sets can be used in the GPM. Which blending width set to be applied to a current block coded in the GPM can be determined from the multiple blending width sets based on information of a block width, a block height, GPM information (e.g., a partition mode), and/or the like. In an aspect, the blending width set to be applied to the current block can be determined from the multiple blending width sets based on the information such as block size information indicating the block width, the block height, an aspect ratio between the block width and the block height, and the like, and the GPM information indicating the partition mode and the like. A blending width can be determined from the determined blending width set and the current block can be reconstructed according to the GPM and the determined blending width.

The multiple blending width sets can include any number of blending width sets, and each of the multiple blending width sets can include any number of blending widths. In an example, two blending width sets are used for the GPM. For example, the multiple blending width sets include a first blending width set (e.g., a blending width set #1) and a second blending width set (e.g., a blending width set #2). In an aspect, a smallest blending width in the first blending width set is less than a smallest blending width in the second blending width set. In an example, the first blending width set is {τ/4, τ/2, τ, 2τ, 4τ}, the second blending width set is {τ/2, τ, 2τ, 4τ, 8τ}, and the smallest blending width in the first blending width set is τ/4, which is smaller than the smallest blending width in the second blending width set τ/2. In an aspect, a largest blending width (e.g., 4τ) in the first blending width set is less than a largest blending width (e.g., 8τ) in the second blending width set.

In an aspect, when the block width and the block height satisfy a first condition, the blending width set of the current block can be determined as the blending width set #1. When the block width and the block height satisfy a second condition, the blending width set of the current block can be determined as the blending width set #2. When the block width and the block height do not satisfy the first condition and do not satisfy the second condition, the blending width set can be determined as one of the first blending width set and the second blending width set based on the partition mode in the GPM and the aspect ratio between the block height and the block width. In an example, the aspect ratio is a ratio of the block width over the block height.

In an aspect, the first condition and the second condition can be based on a comparison between i) the block height and the block width and ii) a threshold value T.

In an example, the first condition includes: both of the block width and block height are smaller than and equal to the threshold value T, and the second condition includes both of the block width and block height are larger than or equal to the threshold value T.

In an example, the first condition includes: both of the block width and block height are smaller than or equal to the threshold value T, and the second condition includes both of the block width and block height are larger than and equal to the threshold value T.

In an example, the first condition includes: each of the block width and block height is smaller than or equal to the threshold value T, and the second condition includes each of the block width and block height is larger than the threshold value T.

In an example, the first condition includes: each of the block width and block height is smaller than the threshold value T, and the second condition includes each of the block width and block height is larger than or equal to the threshold value T.

More specifically in other cases, for example, when the block width and the block height do not satisfy the first condition and do not satisfy the second condition, the blending width set #2 can be selected when one of the following two conditions is true: i) the aspect ratio is larger than 1 and a near vertical partition mode (also referred to as a near vertical geometric partition mode) is used and ii) the aspect ratio is smaller than 1 and a near horizontal partition mode (also referred to as a near horizontal geometric partition mode) is used. Otherwise, for example, when none of the two conditions (i) and (ii) is satisfied, the blending width set #1 can be selected.

In an example, the block width and block height do not satisfy the first condition and do not satisfy the second condition, and the aspect ratio is the block width over the block height. The two conditions can include i) the aspect ratio is larger than 1 and the partition mode in the GPM is the near vertical partition mode and ii) the aspect ratio is smaller than 1 and the partition mode in the GPM is the near horizontal partition mode. The blending width set of the current block can be determined as the second blending width set (e.g., {τ/2, τ, 2τ, 4τ, 8τ}) when one of the two conditions (i) and (ii) is satisfied, and the blending width set can be determined as the first blending width set (e.g., {τ/4, τ/2, τ, 2τ, 4τ}) when none of the two conditions is satisfied.

In an example, the near horizontal partition mode indicates that a geometric partition angle between the geometric split edge of the near horizontal partition mode and the horizontal line is smaller than and/or equal to a first predefined angle. In an example, the partition mode in the GPM is the near horizontal partition mode when the geometric partition angle between the geometric split edge of the partition mode and the horizontal line is smaller than or equal to the first predefined angle.

In an example, the near vertical partition mode indicates that the geometric partition angle between the geometric split edge of the near vertical partition mode and the vertical line is smaller than and/or equal to a second predefined angle. In an example, the partition mode in the GPM is the near vertical partition mode when the geometric partition angle between the geometric split edge of the partition mode and the vertical line is smaller than or equal to the second predefined angle.

In an example, the first predefined angle and the second predefined angle can be the same for all block sizes.

In an example, the first predefined angle and the second predefined angle can be different depending on the block size.

In an example, the first predefined angle and the second predefined angle can be different depending on the aspect ratio value τ (r being the ratio of the block width over the block height) or 1/r. In an example, the first predefined angle and the second predefined angle are the same for the same aspect ratio value τ or 1/r.

According to an aspect of the disclosure, two blending width sets are used for the GPM. In an example, the first blending width set or the blending width set #1 is {τ/4, τ/2, r, 2τ, 4τ} and the second blending width set or the blending width set #2 is {τ/2, τ, 2τ, 4τ, 8τ}. Two threshold values T1 and T2 can be used, and T1 is smaller than T2. The blending width set #1 is used when both of the block width and block height are smaller than and/or equal to the threshold value T1, for example, when each of the block width and block height is smaller than or equal to the threshold value T1. The blending width set #2 is used when both of the block width and block height are larger than or/and equal to the threshold value T2, for example, when each of the block width and block height is larger than or equal to the threshold value T2. In other cases, the blending width set is determined based on the partition mode and the aspect ratio of the block width and the block height as described above.

In an example, the blending width set of the current block is determined as the first blending width set (e.g., {τ/4, τ/2, τ, 2τ, 4τ}) when a third condition that each of the block height and the block width is smaller than or equal to the threshold value T1 is satisfied, and the blending width set is determined as the second blending width set (e.g., {τ/2, τ, 2τ, 4τ, 8τ}) when a fourth condition that each of the block height and the block width is larger than or equal to the threshold value T2. T2 is larger than T1. When the third condition is not satisfied and the fourth condition is not satisfied, the blending width set is determined as one of the first blending width set and the second blending width set based on the partition mode in the GPM and the aspect ratio between the block height and the block width as described above. For example, the third condition is not satisfied, the fourth condition is not satisfied, and the aspect ratio is the block width over the block height. Two conditions include i) the aspect ratio is larger than 1 and the partition mode in the GPM is a near vertical partition mode and ii) the aspect ratio is smaller than 1 and the partition mode in the GPM is a near horizontal partition mode. The blending width set is determined as the second blending width set (e.g., {τ/2, τ, 2τ, 4τ, 8τ}) when one of the two conditions is satisfied. The blending width set is determined as the first blending width set (e.g., {τ/4, τ/2, r, 2τ, 4τ}) when none of the two conditions is satisfied.

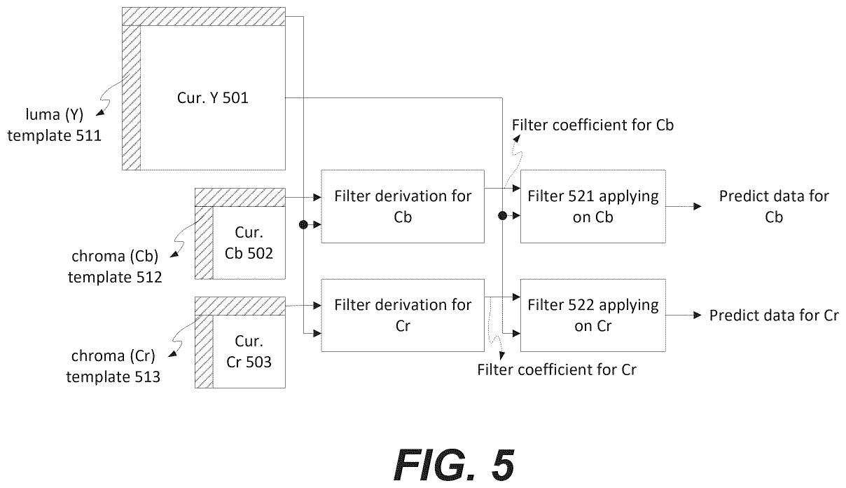

A cross-component prediction in a geometric partition mode for a chroma block is described in the disclosure. In intra prediction coding, a cross-component prediction can be used to predict a chroma prediction block from a luma prediction block by using a linear filter (e.g., a linear filter equation) or a non-linear polynomial filter (e.g., a non-linear polynomial filter equation). Coefficient(s) of the linear or non-linear polynomial equation can be derived from a correlation between a luma template and a chroma template which can include the spatial adjacent reconstructed samples from the above and/or left area of a current block. FIG. 5 shows an example of the cross-component prediction according to an aspect of the disclosure. A luma template (511) of a luma block Y (501) and chroma templates (512)-(513) of respective chroma blocks Cb (502) and Cr (503) are used to derive filter coefficient(s) of filters for the respective chroma blocks (502)-(503). The derived filters can be applied on the luma block (501) to predict the chroma blocks (502)-(503) and generate chroma prediction data for Cb and Cr.

In the example shown in FIG. 5, the luma template (511) and the chroma templates (512)-(513) have an L-shape. Each derived filter (e.g., a filter 521 applying to Cb or a filter 522 applying to Cr) can be a single model filter or a multi-model filter. An example of a multi-model filter can be derived by using an average sample value of a template (e.g., the luma template (511)) as a classifier. Samples having values that are above the average sample value can be used to derive a first filter and other samples having values that are below the average sample value can be used to derive a second filter. The multi-model filter can include the first filter and the second filter.

According to an aspect of the disclosure, a chroma block can be coded based on a corresponding luma block (e.g., a luma block that is collocated with the chroma block where the luma block and the chroma block are in a same CU) using a cross-component prediction (CCP) and a multi-model filter. In an example, the luma block is predicted using the GPM. The luma block can be a luma prediction block or a luma reconstructed block.

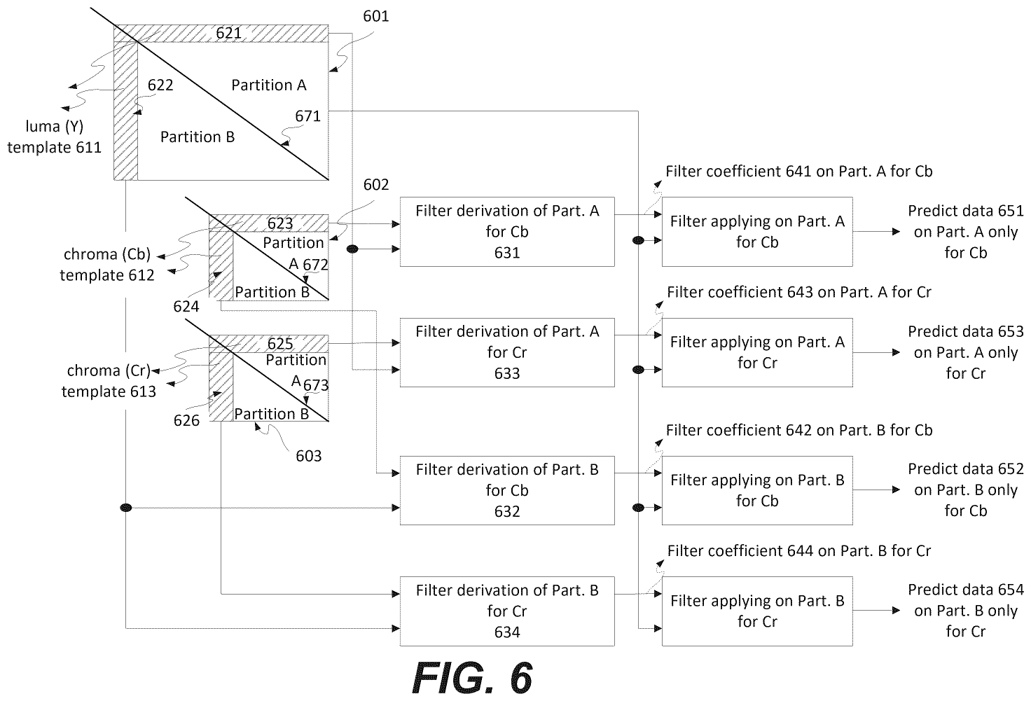

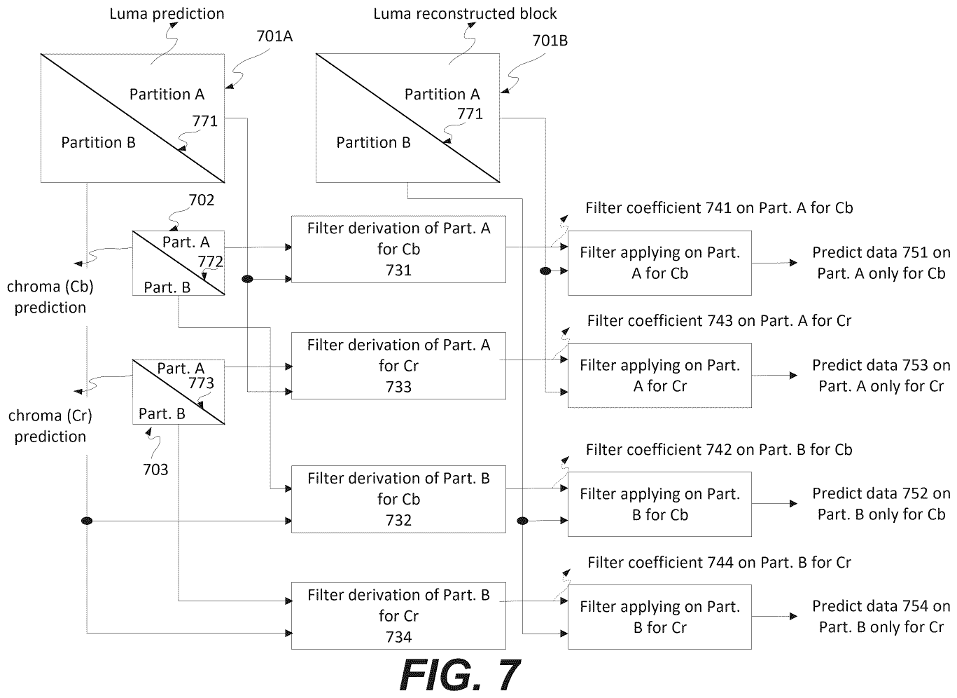

The luma block can include a first partition (also referred to as a Partition A) and a second partition (also referred to as a Partition B) separated by a geometric split edge of the GPM. The chroma block can include a first partition (also referred to as a Partition A) and a second partition (also referred to as a Partition B) separated by a geometric split edge. The multi-model filter for the chroma block can be determined, for example, based on templates (e.g., a luma template and a chroma template) that are adjacent to the luma block and the chroma block, respectively (such as shown in FIG. 6) or prediction blocks of the luma block and the chroma block (such as shown in FIG. 7). In an example, the geometric split edge separating the luma block and the geometric split edge separating the chroma block are determined based on the same partition mode (e.g., a GPM split mode described with reference to FIGS. 4A-4C) of the GPM. For example, the geometric split edge separating the luma block and the geometric split edge separating the chroma block have the same angle (e.g., indicated by one of the angle indices 0-23 in FIG. 4B) and the partition edge (e.g., indicated by one of the indices 0-3 in FIG. 4C).

The luma template of the luma block can be adjacent to the luma block and include reconstructed luma samples. The luma template can include a first luma template and a second luma template separated by an extension of the geometric split edge into the luma template. In an example, the first luma template and the second luma template are referred to as two divided templates. A chroma template of the chroma block can be adjacent to the chroma block and include reconstructed chroma samples. The chroma template can include a first chroma template and a second chroma template separated by an extension of the geometric split edge into the chroma template. In an example, the first chroma template and the second chroma template are referred to as two divided templates.

The multi-model filter can include a first filter having first filter coefficients and a second filter having second filter coefficients. In an aspect, the first filter coefficients are determined based on the first partition of the luma block and the first partition of the chroma block and second filter coefficients are determined based on the second partition of the luma block and the second partition of the chroma block. In an aspect, the first filter coefficients are determined based on the first luma template of the luma block and the first chroma template of the chroma block and the second filter coefficients are determined based on the second luma template of the luma block and the second chroma template of the chroma block. In an example, the chroma block is reconstructed according to the multi-model filter.

In an aspect, the first filter coefficients of the multi-model filter are determined based on the first luma template of the luma block and the first chroma template of the chroma block and the second filter coefficients of the multi-model filter are determined based on the second luma template of the luma block and the second chroma template of the chroma block such as shown in FIG. 6.

FIG. 6 shows an example of a cross-component prediction on the geometric partition block according to an aspect of the disclosure. The luma block Y (601) includes a first partition (a Partition A in FIG. 6) and a second partition (a Partition B in FIG. 6) separated by a geometric split edge 671 of the GPM. The luma block (601) can be a luma prediction block including prediction samples or a luma reconstructed block including reconstructed samples that is determined using the GPM. A chroma block (e.g., a chroma block Cb (602) or a chroma block Cr (603)) can be predicted using the CCP and the multi-model filter.

The chroma block (602) can include a first partition (a Partition A in FIG. 6) and a second partition (a Partition B in FIG. 6) separated by a geometric split edge 672. The chroma block (603) can include a first partition (a Partition A in FIG. 6) and a second partition (a Partition B in FIG. 6) separated by a geometric split edge 673. In an example, the partition mode of the luma block (601) and each partition mode of the chroma blocks (602)-(603) are the same, and thus the geometric split edge 671 for the luma block (601) and the geometric split edge (672)-(673) of the chroma blocks (602)-(603) have the same angle (e.g., indicated by one of the angle indices 0-23 in FIG. 4B) and the same partition edge (e.g., indicated by one of the indices 0-3 in FIG. 4C).

The multi-model filter for the chroma block (602) can be determined based on a luma template (611) and a chroma template (612). The multi-model filter for the chroma block (602) can include a first filter (including first filter coefficients) 641 determined based on a first luma template (621) of the luma block (601) and a first chroma template (623) of the chroma block (602) and a second filter (including second filter coefficients) 642 determined based on a second luma template (622) of the luma block (601) and a second chroma template (624) of the chroma block (602). Referring to FIG. 6, the first filter 641 is determined in a process 631 of filter derivation for the partition A for Cb, and the second filter 642 is determined in a process 632 of filter derivation for the partition B for Cb.

The luma template (611) of the luma block (601) can be adjacent to the luma block (601) and include reconstructed luma samples. The luma template (611) can include the first luma template (621) and the second luma template (622) separated by an extension of the geometric split edge (671) into the luma template (611). The chroma template (612) of the chroma block (602) can be adjacent to the chroma block (602) and include reconstructed chroma samples. The chroma template (612) can include the first chroma template (623) and the second chroma template (624) separated by an extension of the geometric split edge 672 into the chroma template (612).

Similarly, the multi-model filter for the chroma block (603) can be determined based on the luma template (611) and a chroma template (613). The multi-model filter for the chroma block (603) can include a first filter (including first filter coefficients) 643 determined based on the first luma template (621) of the luma block (601) and a first chroma template (625) of the chroma block (603) and a second filter (including second filter coefficients) 644 determined based on the second luma template (622) of the luma block (601) and a second chroma template (626) of the chroma block (603). Referring to FIG. 6, the first filter 643 is determined in a process 633 of filter derivation for the partition A for Cr, and the second filter 644 is determined in a process 634 of filter derivation for the partition B for Cr.

The chroma template (613) of the chroma block (603) can be adjacent to the chroma block (603) and include reconstructed chroma samples. The chroma template (613) can include the first chroma template (625) and the second chroma template (626) separated by an extension of the geometric split edge 673 into the chroma template (613).

Referring to FIG. 6, the chroma block (602) can be predicted using the GPM and the multi-model including the first filter 641 and the second filter 642. In an example, the first filter 641 is applied to the first partition (the Partition A) of the luma block (e.g., the luma prediction block or the luma reconstructed block) to obtain prediction data 651 of the first partition (the Partition A) of Cb. The second filter 642 is applied to the second partition (the Partition B) of the luma block (e.g., the luma prediction block or the luma reconstructed block) to obtain prediction data 652 of the second partition (the Partition B) of Cb.

In another example, the first filter 641 is applied to the luma block (e.g., the luma prediction block or the luma reconstructed block) to obtain first prediction data of Cb, and the second filter 642 is applied to the luma block (e.g., the luma prediction block or the luma reconstructed block) to obtain second prediction data of Cb. The first prediction data of Cb and the second prediction data of Cb can be combined (or blended) using the GPM blending process, such as described with reference to FIG. 4D.

Referring to FIG. 6, the chroma block (603) can be predicted using the GPM and the multi-model including the first filter 643 and the second filter 644. In an example, the first filter 643 is applied to the first partition (the Partition A) of the luma block (e.g., the luma prediction block or the luma reconstructed block) to obtain prediction data 653 of the first partition (the Partition A) of Cr. The second filter 644 is applied to the second partition (the Partition B) of the luma block (e.g., the luma prediction block or the luma reconstructed block) to obtain prediction data 654 of the second partition (the Partition B) of Cr.

In another example, the first filter 643 is applied to the luma block (e.g., the luma prediction block or the luma reconstructed block) to obtain first prediction data of Cr, and the second filter 644 is applied to the luma block (e.g., the luma prediction block or the luma reconstructed block) to obtain second prediction data of Cr. The first prediction data of Cr and the second prediction data of Cr can be combined (or blended) using the GPM blending process, such as described with reference to FIG. 4D.

The geometric split edge which indicates the partition mode (e.g., including the angle shown in FIG. 4B and the partition edge shown in FIG. 4C) can be signaled or derived at a block level, such as at a luma block level or a chroma block level. In an aspect, the geometric split edge which indicates the partition mode can be signaled or derived (derived from luma block) at a chroma block or a chroma prediction block (e.g., the chroma block (602) or (603)). In an aspect, the geometric split edge which indicates the partition mode can be signaled or derived at a luma block (e.g., the luma block (601)) such as a luma prediction block, for example, when a single tree partition structure is used for the luma block (601) and the chroma blocks (602)-(603).

In an example, each partition in the luma block (601) can be predicted, but is not limited to be predicted, using inter prediction, intra prediction, a BV-based prediction, or the like.

In an example, the cross-component prediction using the multi-model filter determined using the GPM (such as described above with reference to FIG. 6) is not allowed when a geometric split edge (e.g., (671)) does not pass through a template (e.g., (611)).

A smaller template in the two divided templates (e.g., the first and second luma templates (621)-(622)) that are separated by the geometric split edge (e.g., (671)) has a size such as a number of samples in the smaller template. A size ratio can be the size of the smaller template over a size of the template. In an example, the cross-component prediction using the multi-model filter determined using the GPM (such as described above with reference to FIG. 6) is not allowed when the size of the smaller template is smaller than a threshold value (e.g., a predefined threshold value) or the size ratio of the smaller template is smaller than a threshold ratio (e.g., a predefined ratio).

The multi-model filter including two filters associated with the GPM mode such as described in FIG. 6 (e.g., the multi-model filter for Cb that includes the two filters (641)-(642)) can be combined with other multi-model filter methods to derive a multi-model filter including more than two filters. In an aspect, a second multi-model filter can be further derived for a geometric partition (e.g., one of the partitions A and B of Cb) by using an average sample value within the associated divided template as a classifier. In an example, a second multi-model filter is derived for each geometric partition by using an average sample value within the associated divided template as a classifier. When a second multi-model filter including 2 filters is derived for each geometric partition of Cb by using an average sample value within the associated divided template as a classifier, a multi-model filter for Cb includes four filters.

Referring to FIG. 6, the second multi-model filter including a third filter and a fourth filter is derived for the first partition (the Partition A) of Cb. A first average sample value of the first luma template (621) is used as a first classifier. The luma samples in the first luma template (621) can be classified into a first subset of luma samples and a second subset of luma samples based on a comparison of values of the luma samples with the first average sample value. Chroma samples in the first chroma template (623) can be classified into a first subset of chroma samples and a second subset of chroma samples where the first subset of chroma samples is collocated with the first subset of luma samples and the second subset of chroma samples is collocated with the second subset of luma samples. Accordingly, the third filter is derived based on the first subset of chroma samples and the first subset of luma samples, and the fourth filter is derived based on the second subset of chroma samples and the second subset of luma samples.

In an example, a second multi-model filter is derived for the second partition (the Partition B) of Cb similarly as described above for the first partition of Cb.

In an example, a second multi-model filter is derived for the first partition (the Partition A) of Cr or the second partition (Partition B) of Cr similarly as described above for the first partition of Cb.

In an example, a flag is signaled for each partition (also referred to as each geometric partition) to indicate whether a multi-model filter (e.g., a second multi-model filter) is used for the partition or not. When the flag is true, the second multi-model filter is derived for the geometric partition. Otherwise, a single-model filter is derived for the geometric partition.

In an example, a flag is signaled at a block level to indicate whether the second multi-model filter is derived or not for both geometric partitions. When the flag is true, the second multi-model filter can be determined using the associated average sample value classifier and can be used for each of the geometric partitions. Otherwise, a single-model filter without the average sample value classifier is used for each geometric partition.

The multi-model filter can be a linear filter such as a linear equation or a nonlinear filter such as a nonlinear polynomial equation.

In an aspect, the chroma prediction data can be predicted from the luma prediction data or the luma reconstructed data using the following equation, P_{c}=α×Pₗ+β, where α and β are the filter coefficients, and P_{c} and Pₗ are a predicted chroma sample and a corresponding predicted or reconstructed luma sample in the luma block. Referring to FIG. 6, in an example, the filters 641-642 can have different values for the filter coefficients α and β.

In an aspect, the chroma prediction data can be predicted from the luma prediction data or the luma reconstructed data using the following polynomial equation with n coefficients, C=Σ_{i∈[0 . . . (n-2)]}Cᵢ×Lᵢ+cₙ₋₁, where C_{i∈[0 . . . (n-1)]} are the filter coefficients, and C, L₀, and L_{i≠0} are the predicted chroma sample, the corresponding predicted or reconstructed luma sample and surrounding luma samples of the corresponding predicted/reconstructed luma sample in the luma block. Referring to FIG. 6, in an example, the filters 641-642 can have different values for the filter coefficients c_{i∈[0 . . . (n-1)]}.

In an aspect, the chroma prediction data can be predicted from the luma prediction data or the luma reconstructed data using the following polynomial equation with non-linear terms,

$$C = {\sum }_{i ϵ [ 0 … ( n - 1 ) ]} {c}_{i} \times {L}_{i} + {\sum }_{j ϵ [ 0 … ( m - 1 ) ]} {c}_{j + n} \times {L}_{j}^{2} + {c}_{n + m} ,$$

where C_{i∈[0 . . . (n-1)]}, C_{j∈[0 . . . (m-1)]}, and cₙ₊ₘ are the filter coefficients, and C, L₀, and L_{i,j≠0} (e.g., L_{i≠0} and L_{j≠0}) are the predicted chroma sample, the corresponding predicted luma or reconstructed sample and the surrounding luma samples of the corresponding predicted/reconstructed luma sample in the luma block. Referring to FIG. 6, in an example, the filters 641-642 can have different values for the filter coefficients C_{i∈[0 . . . (n-1)]}, C_{j∈[0 . . . (m-1)]}, and Cₙ₊ₘ.

In an aspect, more than two different filter equations can be utilized, and a syntax can be signaled to indicate which filter equation is selected.

According to an aspect of the disclosure, the first filter coefficients of the multi-model filter can be determined based on first prediction luma samples in the first partition of the luma block and first prediction chroma samples in the first partition of the chroma block and the second filter coefficients of the multi-model filter can be determined based on second prediction luma samples in the second partition of the luma block and second prediction chroma samples in the second partition of the chroma block such as shown in FIG. 7.

FIG. 7 shows an example of a cross-component prediction for the GPM according to an aspect of the disclosure. In an example, the luma prediction block is coded in geometric partition mode with inter prediction for the first partition and inter prediction for the second partition. The derived filter (e.g., the multi-model filter) is applied on the corresponding geometric partition of a luma reconstructed block to predict a chroma prediction block. The cross-component prediction can be applied with the GPM when at least one geometric partition is coded in inter prediction or BV-based prediction. The filter is derived by using the above method, and is applied on that geometric partition.

A luma block can be a luma prediction block (701A) or a luma reconstructed block (701B). The luma prediction block (701A) includes a first partition (a Partition A in FIG. 7) and a second partition (a Partition B in FIG. 7) separated by a geometric split edge 771 of the GPM. The luma reconstructed block (701B) includes a first partition (a Partition A in FIG. 7) and a second partition (a Partition B in FIG. 7) separated by the geometric split edge 771. The luma prediction block (701A) is predicted using the GPM. The luma reconstructed block (701B) is determined based on the luma prediction block (701A) and includes luma reconstructed samples.

A chroma prediction block Cb (702) that is a prediction block of a chroma block Cb and a chroma prediction block Cr (703) that is a prediction block of a chroma block Cr can be predicted using the GPM. The chroma prediction block Cb (702) can include a first partition (a Partition A in FIG. 7) and a second partition (a Partition B in FIG. 7) separated by a geometric split edge 772. The chroma prediction block Cr (703) can include a first partition (a Partition A in FIG. 7) and a second partition (a Partition B in FIG. 7) separated by a geometric split edge 773. In an example, the partition mode of the luma block and each partition mode of the chroma blocks Cb and Cr are the same, and thus the geometric split edge 771 for the luma block and the geometric split edge (772)-(773) of the chroma blocks Cb and Cr are the same.

Each geometric partition can be predicted using inter prediction or BV-based prediction (e.g., the IBC mode or the IntraTMP mode) and can be used to derive the filter model from the corresponding prediction blocks. In an example, each partition of the luma prediction block (701A), the chroma prediction block Cb (702), or the chroma prediction block Cr (703) can be predicted using the inter prediction or the BV-based prediction (e.g., the IBC mode or the IntraTMP mode). In an example, none of the partitions of the luma prediction block (701A), the chroma prediction block Cb (702), and the chroma prediction block Cr (703) is predicted using intra prediction.

In an example, referring to FIG. 7, the luma prediction block (701A) is coded in the GPM with a first inter prediction mode for the first partition and a second inter prediction mode for the second partition. In an example, it is not necessary to have inter prediction or the BV-based prediction (e.g., the IBC mode or the IntraTMP mode) for both partitions. For example, the luma prediction block (701A) is coded in the GPM with an inter prediction mode for one of the first partition and the second partition and with a BV-based prediction mode for another one of the first partition and the second partition. In an example, the luma prediction block (701A) is coded in the GPM with a first BV prediction mode for the first partition and with a second BV-based prediction mode for the second partition.

The luma prediction block (701A) and a chroma prediction block (e.g., the chroma prediction block Cb (702) or the chroma prediction block Cr (703)) can be used to determine the multi-model filter for the chroma block (e.g., the chroma block Cb or Cr). The multi-model filter for the chroma block Cb can be determined based on the luma prediction block (701A) and the chroma prediction block Cb (702). The multi-model filter for the chroma block Cb can include a first filter (including first filter coefficients) 741 determined based on the first partition of the luma prediction block (701A) and the first partition of the chroma prediction block (702) and a second filter (including second filter coefficients) 742 determined based on the second partition of the luma prediction block (701A) and the second partition of the chroma prediction block (702). Referring to FIG. 7, the first filter 741 is determined in a process 731 of filter derivation for the partition A for Cb, and the second filter 742 is determined in a process 732 of filter derivation for the partition B for Cb.

Similarly, the multi-model filter for the chroma block Cr can be determined based on the luma prediction block (701A) and the chroma prediction block Cr (703). The multi-model filter for the chroma block Cr can include a first filter (including first filter coefficients) 743 determined based on the first partition of the luma prediction block (701A) and the first partition of the chroma prediction block (703) and a second filter (including second filter coefficients) 744 determined based on the second partition of the luma prediction block (701A) and the second partition of the chroma prediction block (703). Referring to FIG. 7, the first filter 743 is determined in a process 733 of filter derivation for the partition A for Cr, and the second filter 744 is determined in a process 734 of filter derivation for the partition B for Cr.

Referring to FIG. 7, the chroma block Cb can be predicted using the GPM and the multi-model including the first filter 741 and the second filter 742. In an example, the first filter 741 is applied to the first partition (the Partition A) of the luma reconstructed block (701B) to obtain prediction data 751 of the first partition (the Partition A) of Cb. The second filter 742 is applied to the second partition (the Partition B) of the luma reconstructed block (701B) to obtain prediction data 752 of the second partition (the Partition B) of Cb.

In another example, the first filter 741 is applied to the luma reconstructed block (701B) to obtain first prediction data of Cb, and the second filter 742 is applied to the luma reconstructed block (701B) to obtain second prediction data of Cb. The first prediction data of Cb and the second prediction data of Cb can be combined (or blended) using the GPM blending process, such as described with reference to FIG. 4D.

Referring to FIG. 7, the chroma block Cr can be predicted using the GPM and the multi-model including the first filter 743 and the second filter 744. In an example, the first filter 743 is applied to the first partition (the Partition A) of the luma reconstructed block (701B) to obtain prediction data 753 of the first partition (the Partition A) of Cr. The second filter 744 is applied to the second partition (the Partition B) of the luma reconstructed block (701B) to obtain prediction data of the second partition (the Partition B) of Cr.

In another example, the first filter 743 is applied to the luma reconstructed block (701B) to obtain first prediction data of Cr, and the second filter 744 is applied to the luma reconstructed block (701B) to obtain second prediction data of Cr. The first prediction data of Cr and the second prediction data of Cr can be combined (or blended) using the GPM blending process, such as described with reference to FIG. 4D.

In an example, the methods described in FIGS. 6-7 can be combined together to derive the filter coefficients for the geometric partition prediction mode. For example, the predict data (651)-(654) can be blended with the respective predict data (751)-(754).

In an example, a multi-model filter can be derived for a geometric partition (e.g., the partition A of Cb) which is predicted from inter prediction or a BV-based prediction, similarly to that described in FIG. 6. In an example, an average sample value, for example, an average sample value of the corresponding partition in the luma prediction block (701A) can be the classifier of the multi-model filter derivation.

In an example, a filter can be derived between the luma prediction and the chroma prediction, e.g., the filter 741 is derived between the partition A of the luma prediction block (701A) and the partition A of the chroma prediction block (702). The derived filter 741 can be applied to the luma prediction or the luma reconstruction (e.g., the partition A of the luma reconstructed block (701B) to generate the final chroma predict data.

In an example, the final chroma predict data can be a weighted sum of the predict data (e.g., in the case without the blending process, the predict data refers to one or more of (751)-(754) shown on the right column) and the original prediction block (e.g., (702)-(703)) shown on the left column. The weight can be a predefined weight. In an example, the weight of the original prediction block (e.g., (702) or (703)) is 0.25.

In an example, a transform unit syntax is signaled to indicate whether the method described in FIG. 7 is applied or not when the luma block is coded with a geometric partition mode and there is no intra prediction for the geometric partition. In an example, the transform unit syntax is implicitly as false when a coded block flag is not true.

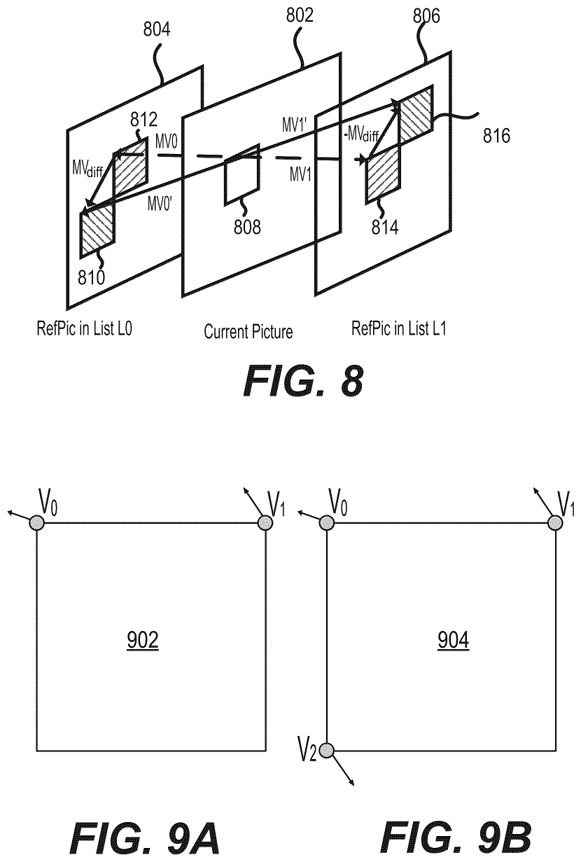

FIG. 8 shows an exemplary schematic view of a bilateral matching (BM)-based decoder side motion vector refinement (DMVR). As show in FIG. 8, a current picture (802) can include a current block (808). The current picture can have a first reference picture (804) from a reference picture list L0 and a second reference picture (806) from a reference picture list L1. For the current block (808), according to initial motion vectors MV₀ and MV₁, a pair of reference blocks are identified in the first and second reference pictures. For example, an initial reference block (812) in the first reference picture (804) can be located according to the initial motion vector MV₀ and an initial reference block (814) in the second reference picture (806) can be located according to the initial motion vector MV₁. A searching process can be performed around the initial MV₀ in the first reference picture (804) and around the initial MV₁ in the second reference picture (806). For example, an adjustment MV_{diff} is applied to the initial MV₀ and MV₁ in the opposite direction to obtain MV candidate, such as MV₀′ and MV₁′. According to the MV candidate, a pair of candidate reference blocks are identified in the first and second reference picture. For example, a candidate reference block (810) can be identified in the first reference picture (804) according to MV₀′ and a candidate reference block (816) can be identified in the second reference picture (806) according to MV₁′. In some examples, bilateral matching refers to an operation that calculates a distortion measure between a pair of reference blocks of respective reference pictures for the current picture, such as a sum of absolute differences (SAD) between a pair of reference blocks as the distortion measure of the pair of reference blocks. For example, BM method calculates an initial SAD between the pair of initial reference blocks (812) and (814), and calculates a second SAD between the pair of candidate reference blocks (810) and (816). The initial SAD is associated with the initial MV (e.g., MV₀ and MV₁), the second SAD is associated with the MV candidate (e.g., MV₀′ and MV₁′). Similarly, BM method can calculate SADs for a plurality of MV candidates around the initial MV. An MV candidate with the lowest SAD can become the refined MV and used to generate a bi-predicted signal to predict the current block (808).

It is noted that the refined MV derived by DMVR process is used to generate the inter prediction samples and can be used in temporal motion vector prediction for future pictures coding. In some examples, the original MV is used in a deblocking process and also used in spatial motion vector prediction for future CU coding.

In DVMR, the search points surround the initial MV and the MV offset obey the MV difference mirroring rule. Any points that are checked by DMVR, denoted by candidate MV pair (MV₀′, MV₁′) obey MV₀′=MV₀+MV_offset and MV₁′=MV₁−MV_offset. Where MV_offset such as MV_{diff} represents the refinement offset between the initial MV (e.g., (MV₀, MV₁) and the refined MV in one of the reference pictures.

In some examples (e.g., VVC), DMVR is applied to CU coded in regular merge mode. The pair of MVs obtained from the regular merge candidate is used as input of the DMVR process. DMVR applies the bilateral matching to refine the input MV pair {MV₀, MV₁} and uses the refined MV pair {MV_{refinedL0}, MV_{refinedL1}} for the motion compensated prediction of both luma and chroma components. The output MVs of DMVR can be referred to as refined MV pair, and can be represented by Eq. 4:

$$M {V}_{refinedL 0} = MV 0 + Δ mv M {V}_{refinedL 1} = MV 1 - Δ mv \qquad Eq . 4$$

The motion vector difference Amy is applied to the input MV pair to obtain the refined MV pair by using the MVD mirroring property, because the input MV pair point to two different reference pictures that have equal difference in picture order count (POC) to the current picture and these two reference pictures are at different temporal direction.

In some examples, DMVR can be applied at subblock level, a luma coded block is divided into 16×16 subblocks for the MV refinement process. The Amy is derived independently for each of the subblocks.

In an aspect, in inter prediction coding, a final MV can be derived based on (i) spatial and/or temporal information or (ii) a summation of a signalled motion vector difference (MVD) and a derived or selected motion vector predictor (MVP). When the final MV is derived based on the spatial and/or temporal information, the inter prediction coding can be referred to as a merge mode, and the final MV can be referred to as a merged MV. A merged MV can be derived from an MV of an adjacent neighbouring coded block, a non-adjacent neighbouring coded block, a collocated coded block in a reference picture, history-based motion information from a previously coded block, or the like. Positions of the coded blocks can be fixed and predefined during merge candidate list construction. When the final MV is the sum of the signalled MVD and the derived or selected MVP, the inter prediction coding or the coded mode can be referred to as an advanced motion vector prediction (AMVP) mode. In the AMVP mode, the MVP can be derived or selected from a candidate list. The candidate list can have at least one MVP in the candidate list. The candidate list construction for the AMVP mode can be similar to the merge candidate list construction in the merge mode.

In HEVC, a translational motion model is applied for motion compensation prediction (MCP). Translational motion is the motion in which all points of a moving body move uniformly in the same line or direction, thus a motion vector can be used to define the motion of the motion body. While in the real world, many kinds of motions can exist, such as zoom in/out, rotation, perspective motions, and other irregular motions. Non-translational motion refers to a motion that points of the moving body do not move uniformly. Some motion models can include translational component for the translational motion and non-translational component for the non-translational motion.

A block-based affine transform motion compensation prediction can be applied, such as in VTM. FIG. 9A shows an affine motion field of a block (902) described by motion information of two control points (4-parameter). FIG. 9B shows an affine motion field of a block (904) described by three control point motion vectors (6-parameter).

As shown in FIG. 9A, in the 4-parameter affine motion model, a motion vector at a sample location (x, y) in the block (902) can be derived in Eq. 5 as follows:

$$\{ \begin{matrix}m {v}_{x} = \frac{m {v}_{1 x} - m {v}_{0 x}}{W} x + \frac{m {v}_{1 y} - m {v}_{0 y}}{W} y + m {v}_{0 x} \\ m {v}_{y} = - \frac{m {v}_{1 y} - m {v}_{0 y}}{W} x + \frac{m {v}_{1 x} - m {v}_{0 x}}{W} y + m {v}_{0 y}\end{matrix} \qquad Eq . 5$$

where mvₓ can be the motion vector in a first direction (or X direction) and mvy can be the motion vector in a second direction (or Y direction). The motion vector can also be described in Eq. 6:

$$\{ \begin{matrix}{mv}_{x} = a x + b y + c \\ {mv}_{y} = - bx + ay + f\end{matrix} \qquad Eq . 6$$

As shown in FIG. 9B, in the 6-parameter affine motion model, a motion vector at a sample location (x, y) in the block (904) can be derived in Eq. 7 as follows:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad Eq . 7$$

The 6-parameter affine motion model can also described in Eq. 8 as follows:

$$\{ \begin{matrix}{mv}_{x} = a x + b y + c \\ {mv}_{y} = d x + e y + f\end{matrix} \qquad Eq . 8$$

As shown in Eq. 5 and Eq. 7, (mv₀ₓ, mv_{0y}) can be a motion vector of a top-left corner control point. (mv₁ₓ, mv_{1y}) can be motion vector of a top-right corner control point. (mv₂ₓ, mv_{2y}) can be a motion vector of a bottom-left corner control point.

The above descriptions related to a merge mode and an AMVP mode can be used in a coding block coded with an affine model. In some examples, such as a versatile video coding (VVC) standard, the 4-parameter affine model (such as shown in FIG. 9A) and the 6-parameter affine model (such as shown in FIG. 9B) can be constructed by using two control point motion vectors (CPMVs) such as V₀ and V₁ and three CPMVs such as V₀, V₁, and V₂, respectively. In an example, we an 8-parameter perspective model can be derived using four CPMVs at four respective corners of the coding block.

In affine merge prediction, an affine merge (AF_MERGE) mode can be applied, for example, to CUs with both a width and a height larger than or equal to 8. CPMVs of a current CU can be generated based on motion information of spatial neighboring CUs. In an example, up to five CPMVP candidates can be applied for the affine merge prediction and an index can be signalled to indicate which one of the five CPMVP candidates can be used for the current CU. In affine merge prediction, one or more types from multiple types of CPMV candidates can be used to form the affine merge candidate list: (1) inherited affine merge candidates that are extrapolated from CPMVs of neighbour CUs, (2) constructed affine merge candidates with CPMVPs that are derived using translational MVs of neighbour CUs, (3) Zero MVs, and/or the like.

In affine AMVP prediction, an affine AMVP mode can be applied, for example, to CUs with both a width and a height larger than or equal to 16. An affine flag in CU level can be signalled in the bitstream to indicate whether affine AMVP mode is used and then another flag can be signaled to indicate whether a 4-parameter affine or a 6-parameter affine is applied. In affine AMVP prediction, a difference of CPMVs of a current CU and predictors of the CPMVPs of the current CU can be signalled in the bitstream. In an example, a size of an affine AMVP candidate list can be 2 and the affine AMVP candidate list can be generated by using one or more types from multiple types of CPMV candidate, for example, in an order as follows: (1) Inherited affine AMVP candidates that are extrapolated from the CPMVs of the neighbour CUs, (2) Constructed affine AMVP candidates with CPMVPs that are derived using the translational MVs of the neighbour CUs, (3) Translational MVs from neighboring CUs, (4) Zero MVs, and/or the like.

According to an aspect of the disclosure, intra template-matching can be applied to an affine motion vector predictor and affine merge candidate construction. In an example, an affine motion vector predictor or an affine merge candidate is determined based on the intra template-matching. In an aspect, a current block in a current picture is coded with an affine mode (e.g., using an affine model). A template-matching process (also referred to as intra template-matching) can be applied to determine a reference block in the current picture. CPMVs of the current block can be determined based on motion vector information associated with a plurality of corners of the reference block. The current block can be reconstructed based on the determined CPMVs of the current block.

In an example, an affine merge candidate used to construct an affine candidate list is derived based on the CPMVs of the current block and the current block is reconstructed based on one of affine merge candidates in the affine candidate list. In an example, an affine motion vector predictor (MVP) of the current block is derived, for example, based on the CPMVs of the current block, and the current block is reconstructed based on the affine MVP.

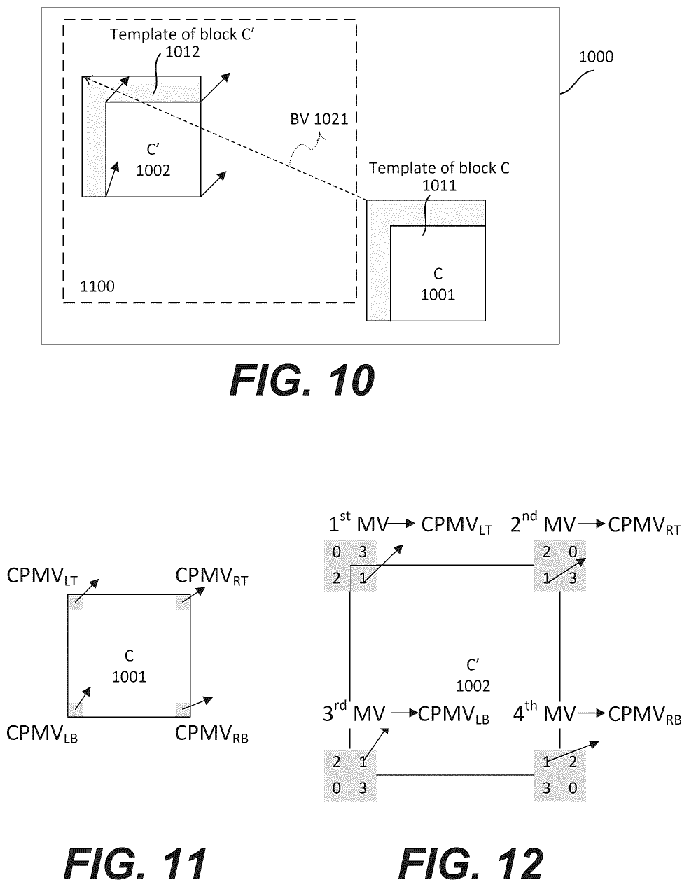

FIG. 10 shows an example of an affine model by using template-matching (TM) in a coded region (e.g., a reconstructed region (1100)) in a current picture (1000). The current picture (1000) is being coded (e.g., under reconstruction). In an example, the coded region (1100) is already coded (e.g., reconstructed). The template-matching processing can be applied in the reconstructed region (1100) in the current picture (1000) to determine at least one reference block C′ (1002) that can be adjacent and/or non-adjacent to a current block (1001). In an example, the current block (1001) is being coded (e.g., under reconstruction). The reference block C′ (1002) is determined by the template-matching process. For example, TM costs are determined based on reference templates of blocks in the reconstructed region (1100) and a current template (1011) of the current block (1001). The reference block (1002) can be determined as one of the blocks with the smallest TM cost in the TM costs. The smallest TM cost is determined based on a reference template (1012) of the reference block (1002) and the current template (1011).

In an example, the template matching process is performed in a pre-defined search area, such as an area that is reconstructed.

In an example, the pre-defined search area is limited to the left N CTU columns of a current CTU column and to the above M CTU rows of a current CTU row, where N and M are positive numbers. The current block (1001) is in a current CTU. The current CTU column is a CTU column including the current CTU. The current CTU row is a CTU row including the current CTU.

In an example, the template matching process is performed with sub-sample operation or sub-sampling to reduce a number of samples used in the template matching process, and thus reducing the complexity.

In an example, a block vector (BV) (1021) indicates the reference block (1002) from the current block (1001). For example, the BV (1021) indicates a position difference between the reference block (1002) and the current block (1001).

The reference block (1002) can have motion vector information and/or block vector information, and the motion vector or block vector information can be used to derive an affine model such as a 4-parameter model, a 6-parameter model, or a perspective 8-parameter model. In an aspect, MVs around at least two of four corners of the reference block C′ (1002) can be used to determine CPMVs of the current block (1001). In an example, the MVs around the at least two of four corners of the reference block C′ (1002) are used directly as the corresponding CPMVs for the affine model derivation of the current block (1001).

In an aspect, an 8-parameter affine/perspective transform model for the current block (1001) can be derived by using the four CPMVs including CPMV_{LT}, CPMV_{RT}, CPMV_{LB}, and CPMV_{RB}, of the current block (1001) when all four CPMVs are available as shown in FIG. 11. The L, R, T, B in the subscript of LT, RT, LB, and RB indicate the position of left, right, top, bottom of the current block (1001), respectively, as shown by the position of corresponding CPMVs in FIG. 11. LT, RT, LB, and RB indicate a top-left corner, a top-right corner, a bottom-left corner, and a bottom-right corner of the current block (1001). Referring to FIG. 11, CPMV_{LT}, CPMV_{RT}, CPMV_{LB}, and CPMV_{RB} are the CPMVs at the respective corners LT, RT, LB, and RB of the current block (1001).

In an example, the 4-parameter affine model or the 6-parameter affine model can be derived from the four CPMVs when at least two or three CPMVs of the four CPMVs are available. In an example, the 4-parameter affine model or the 6-parameter affine model can be derived by selecting two or three motion vectors respectively from available CPMVs. For example, two CPMVs (e.g., either (i) CPMV_{LT} and CPMV_{RT} or (ii) CPMV_{LT} and CPMV_{LB}) are used to derived the 4-parameter affine model when CPMV_{LT}, CPMV_{RT}, and CPMV_{LB} are available.

In an example, a size of the reference block C′ (1002) is identical to a size of the current block C (1001).

In an example, at least one MV (e.g., corresponding to a CPMV, such as one of CPMV_{LT}, CPMV_{RT}, CPMV_{LB}, and CPMV_{RB}) at each corner of the reference block C′ (1002) is derived from MV(s) around the respective corner of the reference block C′ (1002) in a predefined scanning order. Each corner can have its own scanning order. FIG. 12 shows an example of CPMV derivation at corners (e.g., four corners) of the reference block C′ (1002) according to an aspect of the disclosure. Numbers at each corner of the reference block C′ (1002), such as 0, 1, 2, and 3, indicate blocks at the respective corner. The numbers can indicate a scanning order of the respective corner. In an example, a block indicated by a first number is scanned prior to scanning a block indicated by a second number when the first number is smaller than the second number.

Referring to FIG. 12, at each corner of the reference block C′ (1002), a scanning order is 0, 1, 2, and 3. For example, at the LT corner of the reference block C′ (1002), a block located at the top-left position is scanned, followed by a block located at the bottom-right position, a block located at the bottom-left position, and a block located at the top-right position. In an example, the block (indicated by “0”) located at the top-left position has a first MV (1^{st} MV shown in FIG. 12) associated with the block, and the first MV associated with the block “0” is determined as the MV at the LT corner of the reference block C′ (1002). Referring to FIG. 12, the first MV, a second MV (e.g., 2^{nd} MV shown in FIG. 12), a third MV (e.g., 3^{rd} MV shown in FIG. 12), and a fourth MV (e.g., 4^{th} MV shown in FIG. 12) are determined for the corners LT, RT, LB, and RB of the reference block (1002). In an example, the first MV, the second MV, the third MV, and the fourth MV are used to determine CPMV_{LT}, CPMV_{RT}, CPMV_{LB}, and CPMV_{RB}, respectively.

In an example, multiple blocks (e.g., the blocks indicated by “0”, “1”, “2”, and “3) located at one (e.g., LT) of the plurality of corners of the reference block (1002) are scanned in the predefined scanning order (e.g., from 0 to 3) to determine a motion vector associated with one of the multiple blocks. The motion information associated with the plurality of corners of the reference block includes the determined motion vector (e.g., the determined motion vector is used directly as CPMV_{LT}) associated with one of the one of the multiple blocks. In an example, the first MV is used directly as the CPMV_{LT} of the current block (1001).

The motion vector information associated with the plurality of corners of the reference block includes motion vectors associated with the plurality of corners. The CPMVs of the current block can be determined as vector sums of the respective motion vectors associated with the plurality of corners and the BV. In an example, the CPMV_{LT} of the current block (1001) is determined based on the first MV. For example, the BV (1021) shown in FIG. 10 derived from the template matching process can be added as an offset of each derived MV at the corners of the reference block (1002). For each corner of the current block (1001), the final CPMV the (e.g., CPMV_{LT}) can be equal to a sum of the derived MV at the corner of the reference block (1002) and the BV (1021). For example, CPMV_{LT} of the LT corner of the current block (1001)=the first MV of the LT corner of the reference block (1002)+BV (1021). For example, CPMV_{RT} of the RT corner of the current block (1001)=the second MV+BV (1021).

In an example, each CPMV for the current block (1001) is derived from a predefined position or a predefined position list. In an example, the four CPMVs for the current block (1001) are derived at each predefined four corner position as shown in FIG. 12. For example, CPMV_{LT} of the current block (1001) is derived from the LT position of the reference block (1002). In an example, the CPMV at each corner is derived from the MV around the respective corner in the predefined scanning order described above with reference to FIG. 12.

In an example, a linear regression method such as a regression-based affine merge) is applied on multiple positions around the corner of the selected CPMVs to derive the affine parameters. In an example, MVs from the multiple positions (e.g., LT, RT, LB, and/or RB), such as 4 MVs associated with LT, 4 MVs associated with RT, 4 MVs associated with LB, and 4 MVs associated with RB are used to solve a linear regression equation to derive the parameters used in the affine mode. In an example, a number (e.g., 4) of the multiple positions around each corner of the selected CPMVs are identical for the regression-based affine parameter derivation.

In an example, all selected CPMVs point to the same reference picture when the selected CPMVs are used to derive an affine model, such as the 4-parameter affine model, the 6-parameter affine model, or the perspective model (e.g., the 8-parameter affine model).

In an example, a temporal scaling can be applied to a selected CPMV when a reference picture pointed by the selected CPMV is different from a targeted reference picture for the current block C (1001). The targeted reference picture can be determined using a suitable method. In an example, the targeted reference picture is determined as a reference picture pointed to by a majority of the CPMVs. In an example, the targeted reference picture is a specific reference picture, for example, a reference picture with a reference index 0.

In an example, the selected CPMVs are used to construct an affine merge candidate, for example, for the affine merge mode when all the selected CPMVs have the same prediction direction (e.g., a first reference picture list L0 or a second reference picture list L1) and point to the same reference picture. A number of the selected CPMVs can be 2, 3, or 4. In this case, the constructed affine merge candidate can be inserted into an affine merge candidate list for the current block (1001). An affine merge candidate can be selected from the affine merge candidate list, and can be used in the affine mode to predict the current block (1001).

In an example, the selected CPMVs can be one of the following combinations of two CPMVs from CPMV_{LT}, CPMV_{RT}, CPMV_{LB}, and CPMV_{RB}, such as (i) CPMV_{LT} and CPMV_{RT}, (ii) CPMV_{LT} and CPMV_{LB}, (iii) CPMV_{RT} and CPMV_{RB}, and (iv) CPMV_{LB} and CPMV_{RB}, when the number of the selected CPMVs is 2.

In an example, the selected CPMVs can be one of the following combinations of three CPMVs from CPMV_{LT}, CPMV_{RT}, CPMV_{LB}, and CPMV_{RB}, such as [CPMV_{LT}, CPMV_{RT}, CPMV_{LB}], [CPMV_{LT}, CPMV_{RT}, CPMV_{RB}], [CPMV_{LT}, CPMV_{LB}, CPMV_{RB}], and [CPMV_{RT}, CPMV_{LB}, CPMV_{RB}], when the number of the selected CPMVs is 3.

In an example, the selected CPMVs are used to construct an affine MVP, for example, for the affine AMVP mode, when all selected CPMVs have same prediction direction and point to the same reference picture. The number of the selected CPMVs can be 2, 3, or 4. The construct ed affine MVP can be used to predict the current block (1001).

In an example, the number of the selected CPMVs for both reference directions (or for both reference lists L0 and L1) is identical.

In an example, the CPMV derivation is used to derive the affine merge candidate used to construct the affine merge candidate list or affine MVP used to predict the current block (1001).

In an example, the bilateral matching process such as the BM-based decoder side motion vector refinement can be applied when the derived affine merge candidate or the derived affine MVP is a bi-prediction affine MV.

The term “IBC mode” may refer to the IBC mode or a variant. The term “IntraTMP mode” may refer to the IntraTMP mode or a variant. The term “GPM” may refer to the GPM or a variant. The term “affine mode” may refer to the affine mode or a variant.

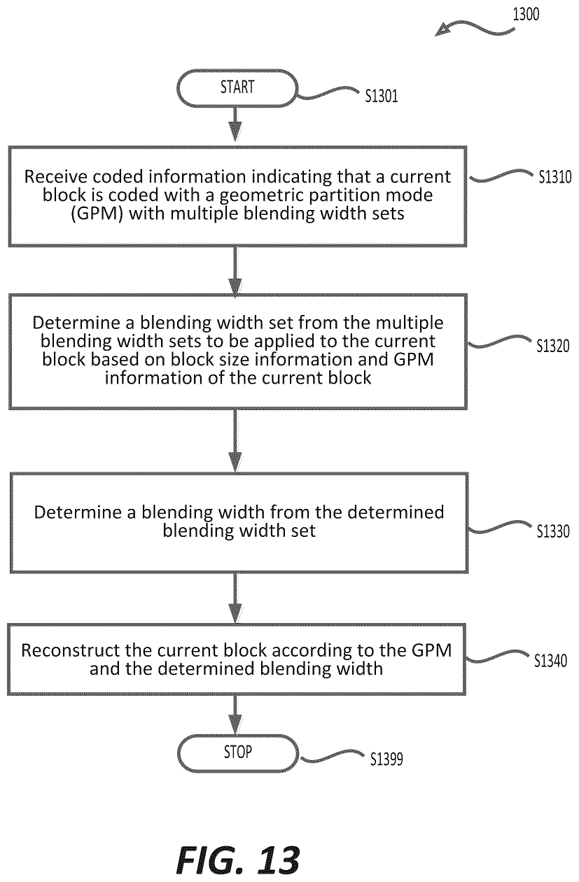

FIG. 13 shows a flow chart outlining a process (1300) according to an aspect of the disclosure. The process (1300) may be used in an apparatus, such as a video decoder. In various aspects, the process (1300) is executed by processing circuitry, such as the processing circuitry that performs functions of the video decoder (110), the processing circuitry that performs functions of the video decoder (210), and the like. In some aspects, the process (1300) is implemented in software instructions, thus when the processing circuitry executes the software instructions, the processing circuitry performs the process (1300). The process starts at (S1301) and proceeds to (S1310).

At (S1310), coded information indicating that a current block is coded with a geometric partition mode (GPM) with multiple blending width sets is received.

At (S1320), a blending width set is determined from the multiple blending width sets to be applied to the current block based on block size information and GPM information of the current block.

In an example, the multiple blending width sets comprises a first blending width set {τ/4, τ/2, τ, 2τ, 4τ} and a second blending width set {τ/2, τ, 2τ, 4τ, 8τ}, and τ is positive.

In an example, the block size information indicates a block height and a block width of the current block. When the block width and the block height satisfy a first condition, the blending width set is determined as the first blending width set based on a comparison between (i) both the block height and the block width and (ii) a threshold value T. When the block width and the block height satisfy a second condition, the blending width set is determined as the second blending width set. The first condition and the second condition are based on a comparison between (i) both the block height and the block width and (ii) the threshold value T. When the block width and the block height do not satisfy the first condition and do not satisfy the second condition, the blending width set is determined as one of the first blending width set and the second blending width set based on a partition mode in the GPM and an aspect ratio between the block height and the block width.

In an example, the block width and the block height do not satisfy the first condition and do not satisfy the second condition, and the aspect ratio is the block width over the block height. Two conditions include (i) the aspect ratio is larger than 1 and the partition mode in the GPM is a near vertical partition mode and (ii) the aspect ratio is smaller than 1 and the partition mode in the GPM is a near horizontal partition mode. The blending width set is determined as the second blending width set when one of the two conditions is satisfied. The blending width set is determined as the first blending width set when none of the two conditions is satisfied.

In an example, the partition mode in the GPM is the near horizontal partition mode when a geometric partition angle between a geometric split edge of the near horizontal partition mode and a horizontal line is smaller than or equal to a predefined angle.

In an example, the partition mode in the GPM is the near vertical partition mode when a geometric partition angle between a geometric split edge of the near vertical partition mode and a vertical line is smaller than or equal to a predefined angle.

In an example, the block size information indicates a block height and a block width of the current block. A smallest blending width in the first blending width set is less than a smallest blending width in the second blending width set. The blending width set is determined as the first blending width set when a third condition that each of the block height and the block width is smaller than or equal to a threshold value T1 is satisfied. The blending width set is determined as the second blending width set when a fourth condition that each of the block height and the block width is larger than or equal to a threshold value T2 is satisfied. T2 is larger than T1. When the third condition is not satisfied and the fourth condition is not satisfied, the blending width set is determined as one of the first blending width set and the second blending width set based on a partition mode in the GPM and an aspect ratio between the block height and the block width.

In an example, the third condition is not satisfied, the fourth condition is not satisfied, and the aspect ratio is the block width over the block height. Two conditions include (i) the aspect ratio is larger than 1 and the partition mode in the GPM is a near vertical partition mode and (ii) the aspect ratio is smaller than 1 and the partition mode in the GPM is a near horizontal partition mode. The blending width set is determined as the second blending width set when one of the two conditions is satisfied. The blending width set is determined as the first blending width set when none of the two conditions is satisfied.

At (S1330), a blending width is determined from the determined blending width set.

At (S1340), the current block is reconstructed according to the GPM and the determined blending width.

Then, the process proceeds to (S1399) and terminates.

The process (1300) may be suitably adapted. Step(s) in the process (1300) may be modified and/or omitted. Additional step(s) may be added. Any suitable order of implementation may be used.

A method for video encoding can include determining a blending width set from multiple blending width sets to be applied to a current block based on block size information and GPM information of the current block such as described above. A method for video encoding can include determining a blending width from the determined blending width set, and encoding the current block according to the GPM and the determined blending width.

Having multiple blending width sets (such as the first blending width set and the second blending width set) for the GPM, and determining one of the multiple blending width sets based on coded information such as block size information and GPM information of a current block can reduce a number of bits used to indicate a blending width, and thus increasing coding efficiency. For example, the determination of the one of the multiple blending width sets is performed implicitly, and thus no addition bits is signaled for the determination of the one of the multiple blending width sets.

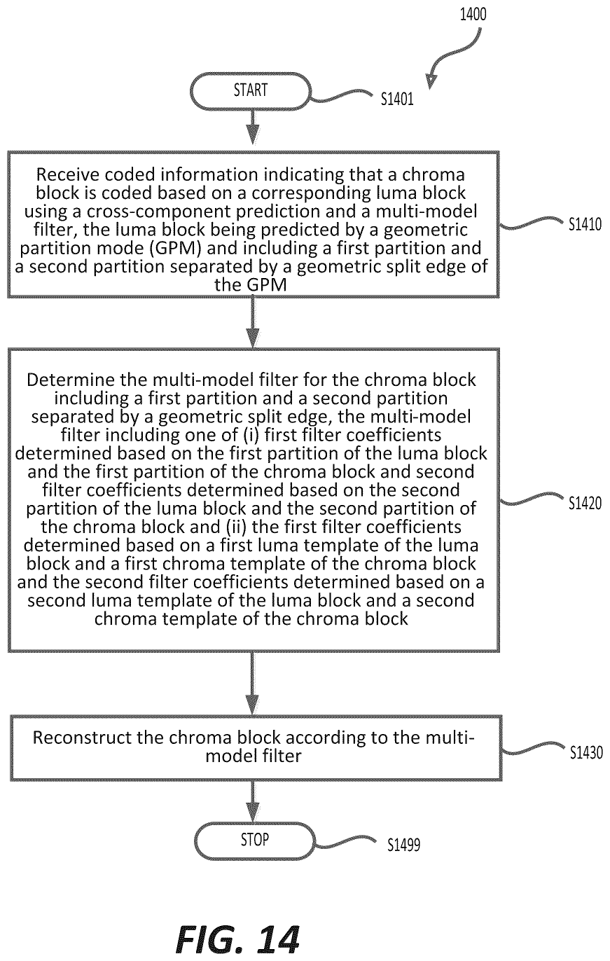

FIG. 14 shows a flow chart outlining a process (1400) according to an aspect of the disclosure. The process (1400) may be used in an apparatus, such as a video decoder. In various aspects, the process (1400) is executed by processing circuitry, such as the processing circuitry that performs functions of the video decoder (110), the processing circuitry that performs functions of the video decoder (210), and the like. In some aspects, the process (1400) is implemented in software instructions, thus when the processing circuitry executes the software instructions, the processing circuitry performs the process (1400). The process starts at (S1401) and proceeds to (S1410).

At (S1410), coded information indicating that a chroma block is coded based on a corresponding luma block using a cross-component prediction and a multi-model filter is received. The luma block is predicted by a geometric partition mode (GPM) and includes a first partition and a second partition separated by a geometric split edge of the GPM.

At (1420), the multi-model filter for the chroma block including a first partition and a second partition separated by a geometric split edge is determined. The multi-model filter includes one of (i) first filter coefficients determined based on the first partition of the luma block and the first partition of the chroma block and second filter coefficients determined based on the second partition of the luma block and the second partition of the chroma block and (ii) the first filter coefficients determined based on a first luma template of the luma block and a first chroma template of the chroma block and the second filter coefficients determined based on a second luma template of the luma block and a second chroma template of the chroma block.

A luma template of the luma block is adjacent to the luma block and includes reconstructed luma samples. The luma template includes the first luma template and the second luma template separated by an extension of the geometric split edge into the luma template. A chroma template of the chroma block is adjacent to the chroma block and includes reconstructed chroma samples. The chroma template includes the first chroma template and the second chroma template separated by an extension of the geometric split edge into the chroma template.

In an example, the first filter coefficients of the multi-model filter is determined based on the first luma template of the luma block and the first chroma template of the chroma block. The second filter coefficients of the multi-model filter is determined based on the second luma template of the luma block and the second chroma template of the chroma block.

At (S1430), the chroma block is reconstructed according to the multi-model filter.

Then, the process proceeds to (S1499) and terminates.

The process (1400) may be suitably adapted. Step(s) in the process (1400) may be modified and/or omitted. Additional step(s) may be added. Any suitable order of implementation may be used.

In an example, the geometric split edge (e.g., separating the chroma block) is signaled or derived at the chroma block.

In an example, the geometric split edge separating the chroma block is signaled or derived at the luma block when a single tree partition structure is used for the luma block and the chroma block.

In an example, the multi-model filter is a linear filter.

In an example, the multi-model filter is a non-linear polynomial filter.

In an example, the multi-model filter and the GPM are applied to prediction samples or reconstructed samples of the luma block to reconstruct the chroma block.

In an example, the first filter coefficients of the multi-model filter are determined based on first prediction luma samples in the first partition of the luma block and first prediction chroma samples in the first partition of the chroma block. The second filter coefficients of the multi-model filter are determined based on second prediction luma samples in the second partition of the luma block and second prediction chroma samples in the second partition of the chroma block.

A method for video encoding can include determining a multi-model filter for a chroma block including a first partition and a second partition separated by a geometric split edge. The chroma block is encoded based on a corresponding luma block using a cross-component prediction and the multi-model filter, and the luma block is predicted by the GPM and includes a first partition and a second partition separated by a geometric split edge of the GPM. The multi-model filter includes one of (i) first filter coefficients determined based on the first partition of the luma block and the first partition of the chroma block and second filter coefficients determined based on the second partition of the luma block and the second partition of the chroma block and (ii) the first filter coefficients determined based on a first luma template of the luma block and a first chroma template of the chroma block and the second filter coefficients determined based on a second luma template of the luma block and a second chroma template of the chroma block. A luma template of the luma block is adjacent to the luma block and includes reconstructed luma samples. The luma template includes the first luma template and the second luma template separated by an extension of the geometric split edge into the luma template. A chroma template of the chroma block is adjacent to the chroma block and includes reconstructed chroma samples. The chroma template includes the first chroma template and the second chroma template separated by an extension of the geometric split edge into the chroma template. The method for video encoding can include encoding the chroma block according to the multi-model filter.

In some related technologies, a single model filter is applied to the two partitions in the GPM. In the methods described with reference to FIG. 6 or 7, a multi-model filter is applied to the two partitions without a signaling overhead since the two partitions are implicitly known because of the GPM. Accordingly, more accurate prediction without the signaling overhead can be obtained.

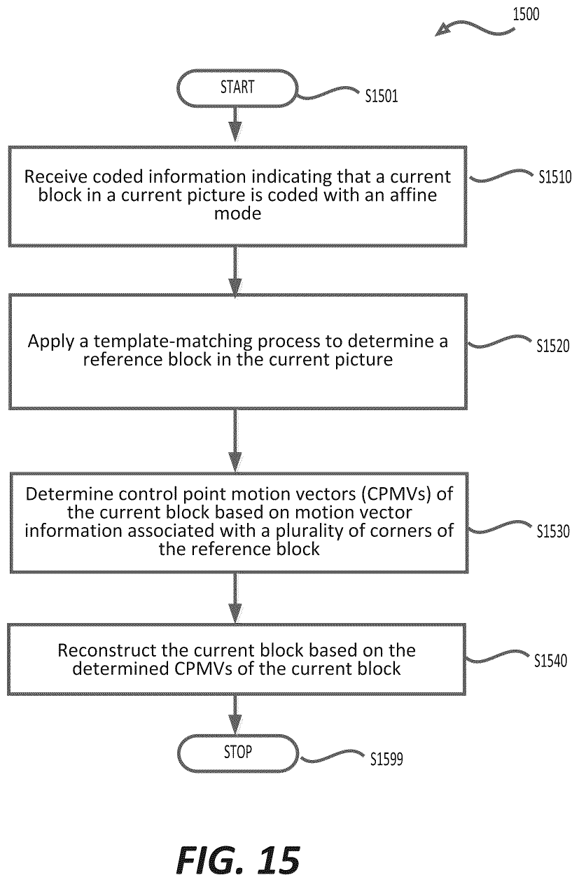

FIG. 15 shows a flow chart outlining a process (1500) according to an aspect of the disclosure. The process (1500) may be used in an apparatus, such as a video decoder. In various aspects, the process (1500) is executed by processing circuitry, such as the processing circuitry that performs functions of the video decoder (110), the processing circuitry that performs functions of the video decoder (210), and the like. In some aspects, the process (1500) is implemented in software instructions, thus when the processing circuitry executes the software instructions, the processing circuitry performs the process (1500). The process starts at (S1501) and proceeds to (S1510).

At (S1510), coded information indicating that a current block in a current picture is coded with an affine mode is received.

At (S1520), a template-matching process is applied to determine a reference block in the current picture.

At (S1530), control point motion vectors (CPMVs) of the current block are determined based on motion vector information associated with a plurality of corners of the reference block.

At (S1540), the current block is reconstructed based on the determined CPMVs of the current block.

Then, the process proceeds to (S1599) and terminates.

The process (1500) may be suitably adapted. Step(s) in the process (1500) may be modified and/or omitted. Additional step(s) may be added. Any suitable order of implementation may be used.

In an example, multiple blocks located at one of the plurality of corners of the reference block are scanned in a predefined scanning order to determine a motion vector associated with one of the multiple blocks. The motion information associated with the plurality of corners of the reference block includes the determined motion vector associated with one of the one of the multiple blocks.

In an example, a block vector (BV) indicates the reference block from the current block. The motion vector information associated with the plurality of corners of the reference block includes motion vectors associated with the plurality of corners. The CPMVs of the current block are determined as vector sums of the respective motion vectors associated with the plurality of corners and the BV.

In an example, an affine merge candidate used to construct an affine candidate list is derived based on the CPMVs of the current block and the current block is reconstructed based on one of affine merge candidates in the affine candidate list. In an example, an affine motion vector predictor (MVP) of the current block is derived and the current block is reconstructed based on the affine MVP.

In an aspect, a method for video encoding includes applying a template-matching process to determine a reference block in a current picture for a current block in the current picture, determining control point motion vectors (CPMVs) of the current block based on motion vector information associated with a plurality of corners of the reference block; and encoding the current block based on the determined CPMVs of the current block with an affine mode.

Compared to related technologies using an affine mode, the methods using intra template-matching described in the disclosure can obtain more accurate CPMVs, and thus more accurate prediction without increasing the signaling overhead.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an aspect, the bitstream includes coded information indicating that a current block is coded with a geometric partition mode (GPM) with multiple blending width sets is received. The format rules specifies that a blending width set is determined from the multiple blending width sets to be applied to the current block based on block size information and GPM information of the current block; a blending width is determined from the determined blending width set; and the current block is reconstructed according to the GPM and the determined blending width.

In an aspect, the bitstream includes coded information indicating that a chroma block is coded based on a corresponding luma block using a cross-component prediction and a multi-model filter is received. The luma block is predicted by a geometric partition mode (GPM) and includes a first partition and a second partition separated by a geometric split edge of the GPM. The format rules specifies that the multi-model filter for the chroma block including a first partition and a second partition separated by a geometric split edge is determined. The multi-model filter includes one of (i) first filter coefficients determined based on the first partition of the luma block and the first partition of the chroma block and second filter coefficients determined based on the second partition of the luma block and the second partition of the chroma block and (ii) the first filter coefficients determined based on a first luma template of the luma block and a first chroma template of the chroma block and the second filter coefficients determined based on a second luma template of the luma block and a second chroma template of the chroma block. A luma template of the luma block is adjacent to the luma block and includes reconstructed luma samples. The luma template includes the first luma template and the second luma template separated by an extension of the geometric split edge into the luma template. A chroma template of the chroma block is adjacent to the chroma block and includes reconstructed chroma samples. The chroma template includes the first chroma template and the second chroma template separated by an extension of the geometric split edge into the chroma template. The format rules further specifies that the chroma block is reconstructed according to the multi-model filter.

In an aspect, the bitstream includes coded information indicating that a current block in a current picture is coded with an affine mode is received. The format rules specifies that a template-matching process is applied to determine a reference block in the current picture; control point motion vectors (CPMVs) of the current block are determined based on motion vector information associated with a plurality of corners of the reference block; and the current block is reconstructed based on the determined CPMVs of the current block.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

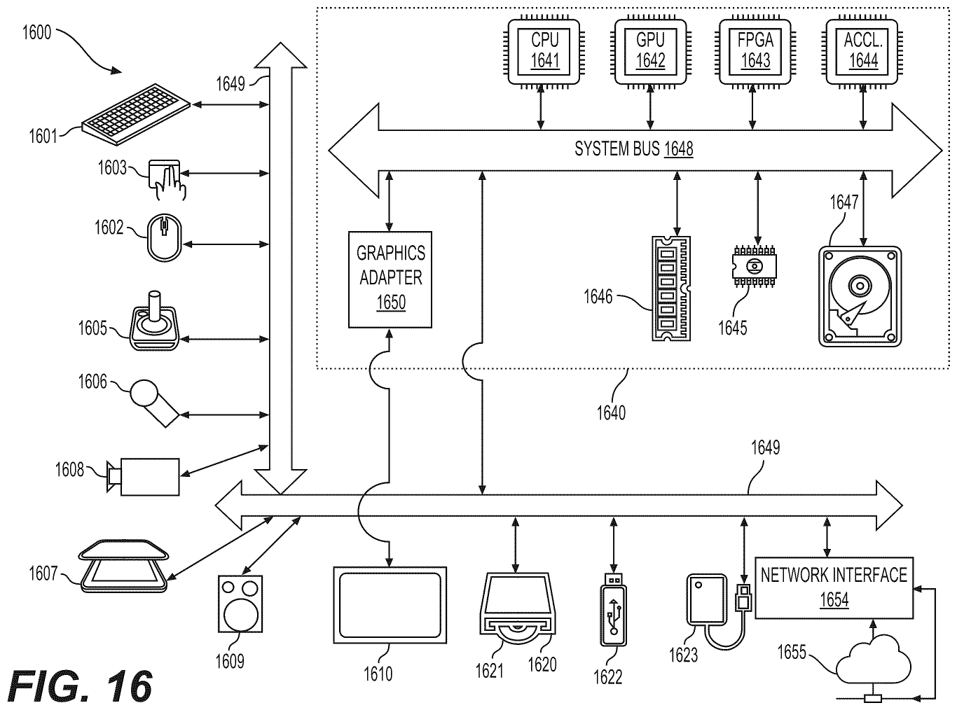

The techniques described above, may be implemented as computer software using computer-readable instructions and physically stored in one or more computer-readable media. For example, FIG. 16 shows a computer system (1600) suitable for implementing certain aspects of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 16 for computer system (1600) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1600).

Computer system (1600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1601), mouse (1602), trackpad (1603), touch screen (1610), data-glove (not shown), joystick (1605), microphone (1606), scanner (1607), camera (1608).

Computer system (1600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1610), data-glove (not shown), or joystick (1605), but there may also be tactile feedback devices that do not serve as input devices), audio output devices (such as: speakers (1609), headphones (not depicted)), visual output devices (such as screens (1610) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1600) may also include human accessible storage devices and their associated media such as optical media including CD/DVD ROM/RW (1620) with CD/DVD or the like media (1621), thumb-drive (1622), removable hard drive or solid state drive (1623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1600) may also include an interface (1654) to one or more communication networks (1655). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1649) (such as, for example USB ports of the computer system (1600)); others are commonly integrated into the core of the computer system (1600) by attachment to a system bus as described below (for example Ethernet interface into a PC computer system or cellular network interface into a smartphone computer system). Using any of these networks, computer system (1600) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (1640) of the computer system (1600).

The core (1640) may include one or more Central Processing Units (CPU) (1641), Graphics Processing Units (GPU) (1642), specialized programmable processing units in the form of Field Programmable Gate Areas (FPGA) (1643), hardware accelerators for certain tasks (1644), graphics adapters (1650), and so forth. These devices, along with Read-only memory (ROM) (1645), Random-access memory (1646), internal mass storage such as internal non-user accessible hard drives, SSDs, and the like (1647), may be connected through a system bus (1648). In some computer systems, the system bus (1648) may be accessible in the form of one or more physical plugs to enable extensions by additional CPUs, GPU, and the like. The peripheral devices may be attached either directly to the core's system bus (1648), or through a peripheral bus (1649). In an example, the screen (1610) may be connected to the graphics adapter (1650). Architectures for a peripheral bus include PCI, USB, and the like.

CPUs (1641), GPUs (1642), FPGAs (1643), and accelerators (1644) may execute certain instructions that, in combination, may make up the aforementioned computer code. That computer code may be stored in ROM (1645) or RAM (1646). Transitional data may also be stored in RAM (1646), whereas permanent data may be stored for example, in the internal mass storage (1647). Fast storage and retrieve to any of the memory devices may be enabled through the use of cache memory, that may be closely associated with one or more CPU (1641), GPU (1642), mass storage (1647), ROM (1645), RAM (1646), and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture (1600), and specifically the core (1640) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (1640) that are of non-transitory nature, such as core-internal mass storage (1647) or ROM (1645). The software implementing various aspects of the present disclosure may be stored in such devices and executed by core (1640). A computer-readable medium may include one or more memory devices or chips, according to particular needs. The software may cause the core (1640) and specifically the processors therein (including CPU, GPU, FPGA, and the like) to execute particular processes or particular parts of particular processes described herein, including defining data structures stored in RAM (1646) and modifying such data structures according to the processes defined by the software. In addition or as an alternative, the computer system may provide functionality as a result of logic hardwired or otherwise embodied in a circuit (for example: accelerator (1644)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method for video decoding, the method including: receiving coded information indicating that a current block is coded with a geometric partition mode (GPM) with multiple blending width sets; determining a blending width set from the multiple blending width sets to be applied to the current block based on block size information and GPM information of the current block; determining a blending width from the determined blending width set; and reconstructing the current block according to the GPM and the determined blending width.
(2) The method of feature (1), in which the multiple blending width sets comprises a first blending width set {τ/4, τ/2, τ, 2τ, 4τ} and a second blending width set {τ/2, r, 2τ, 4τ, 8τ}, and τ is positive.
(3) The method of feature (1) or (2), in which the block size information indicates a block height and a block width of the current block, and the multiple blending width sets includes a first blending width set and a second blending width set; and the determining the blending width set includes: when the block width and the block height satisfy a first condition, determining the blending width set as a first blending width set; when the block width and the block height satisfy a second condition, determining the blending width set as the second blending width set, the first condition and the second condition being based on a comparison between (i) both the block height and the block width and (ii) the threshold value T; and when the block width and the block height do not satisfy the first condition and do not satisfy the second condition, determining the blending width set as one of the first blending width set and the second blending width set based on a partition mode in the GPM and an aspect ratio between the block height and the block width.
(4) The method of feature (3), in which the block width and the block height do not satisfy the first condition and do not satisfy the second condition, and the aspect ratio is the block width over the block height; two conditions include (i) the aspect ratio is larger than 1 and the partition mode in the GPM is a near vertical partition mode and (ii) the aspect ratio is smaller than 1 and the partition mode in the GPM is a near horizontal partition mode; and the determining the blending width set as the one of the first blending width set and the second blending width set includes: determining the blending width set as the second blending width set when one of the two conditions is satisfied; and determining the blending width set as the first blending width set when none of the two conditions is satisfied.
(5) The method of feature (4), in which the partition mode in the GPM is the near horizontal partition mode when a geometric partition angle between a geometric split edge of the partition mode and a horizontal line is smaller than or equal to a predefined angle.
(6) The method of feature (4), in which the partition mode in the GPM is the near vertical partition mode when a geometric partition angle between a geometric split edge of the partition mode and a vertical line is smaller than or equal to a predefined angle.
(7) The method of feature (1), in which the block size information indicates a block height and a block width of the current block, and the multiple blending width sets includes a first blending width set and a second blending width set; a smallest blending width in the first blending width set is less than a smallest blending width in the second blending width set; and the determining the blending width set includes: determining the blending width set as the first blending width set when a third condition that each of the block height and the block width is smaller than or equal to a threshold value T1 is satisfied, and determining the blending width set as the second blending width set when a fourth condition that each of the block height and the block width is larger than or equal to a threshold value T2 is satisfied, T2 being larger than T1; and when the third condition is not satisfied and the fourth condition is not satisfied, determining the blending width set as one of the first blending width set and the second blending width set based on a partition mode in the GPM and an aspect ratio between the block height and the block width.
(8) The method of feature (7), in which the third condition is not satisfied, the fourth condition is not satisfied, and the aspect ratio is the block width over the block height; two conditions include i) the aspect ratio is larger than 1 and the partition mode in the GPM is a near vertical partition mode and ii) the aspect ratio is smaller than 1 and the partition mode in the GPM is a near horizontal partition mode; and the determining the blending width set as the one of the first blending width set and the second blending width set includes: determining the blending width set as the second blending width set when one of the two conditions is satisfied; and determining the blending width set as the first blending width set when none of the two conditions is satisfied.
(9) A method for video decoding, the method including: receiving coded information indicating that a chroma block is coded based on a corresponding luma block using a cross-component prediction and a multi-model filter, the luma block being predicted by a geometric partition mode (GPM) and including a first partition and a second partition separated by a geometric split edge of the GPM; determining the multi-model filter for the chroma block including a first partition and a second partition separated by a geometric split edge, the multi-model filter including one of (i) first filter coefficients determined based on the first partition of the luma block and the first partition of the chroma block and second filter coefficients determined based on the second partition of the luma block and the second partition of the chroma block and (ii) the first filter coefficients determined based on a first luma template of the luma block and a first chroma template of the chroma block and the second filter coefficients determined based on a second luma template of the luma block and a second chroma template of the chroma block, a luma template of the luma block being adjacent to the luma block and including reconstructed luma samples, the luma template including the first luma template and the second luma template separated by an extension of the geometric split edge into the luma template, a chroma template of the chroma block being adjacent to the chroma block and including reconstructed chroma samples, the chroma template including the first chroma template and the second chroma template separated by an extension of the geometric split edge into the chroma template; and reconstructing the chroma block according to the multi-model filter.
(10) The method of feature (9), in which the determining the multi-model filter includes: determining the first filter coefficients of the multi-model filter based on the first luma template of the luma block and the first chroma template of the chroma block and determining the second filter coefficients of the multi-model filter based on the second luma template of the luma block and the second chroma template of the chroma block.
(11) The method of any of features (9) to (10), in which the geometric split edge separating the chroma block is signaled or derived at the chroma block.
(12) The method of any of features (9) to (10), in which the geometric split edge separating the chroma block is signaled or derived at the luma block when a single tree partition structure is used for the luma block and the chroma block.
(13) The method of any of features (9) to (12), in which the multi-model filter is a linear filter.
(14) The method of any of features (9) to (12), in which the multi-model filter is a non-linear polynomial filter.
(15) The method of any of features (9) to (14), in which the reconstructing the chroma block includes: applying the multi-model filter and the GPM to prediction samples or reconstructed samples of the luma block to reconstruct the chroma block.
(16) The method of feature (9), in which the determining the multi-model filter comprises: determining the first filter coefficients of the multi-model filter based on first prediction luma samples in the first partition of the luma block and first prediction chroma samples in the first partition of the chroma block; and determining the second filter coefficients of the multi-model filter based on second prediction luma samples in the second partition of the luma block and second prediction chroma samples in the second partition of the chroma block.
(17) A method for video decoding, the method including: receiving coded information indicating that a current block in a current picture is coded with an affine mode; applying a template-matching process to determine a reference block in the current picture; determining control point motion vectors (CPMVs) of the current block based on motion vector information associated with a plurality of corners of the reference block; and reconstructing the current block based on the determined CPMVs of the current block.
(18) The method of feature (17), further including: scanning multiple blocks located at one of the plurality of corners of the reference block in a predefined scanning order to determine a motion vector associated with one of the multiple blocks, the motion information associated with the plurality of corners of the reference block including the determined motion vector associated with one of the one of the multiple blocks.
(19) The method of feature (17) or (18), in which a block vector (BV) indicates the reference block from the current block; the motion vector information associated with the plurality of corners of the reference block includes motion vectors associated with the plurality of corners; and the determining the CPMVs of the current block includes determining the CPMVs of the current block as vector sums of the respective motion vectors associated with the plurality of corners and the BV.
(20) The method of any of features (17) to (19), in which the reconstructing the current block comprises one of: deriving an affine merge candidate used to construct an affine candidate list based on the CPMVs of the current block and reconstructing the current block based on one of affine merge candidates in the affine candidate list; or deriving an affine motion vector predictor (MVP) of the current block and reconstructing the current block based on the affine MVP.
(21) An apparatus of processing a video bitstream, including processing circuitry that is configured to perform the method of any of features (1) to (20).
(22) A non-transitory computer-readable storage medium storing instructions which when executed by at least one processor cause the at least one processor to perform the method of any of features (1) to (20).

What is claimed is:

1. A method for video decoding, the method comprising:
receiving coded information indicating that a current block is coded with a geometric partition mode (GPM) with multiple blending width sets;
determining a blending width set from the multiple blending width sets to be applied to the current block based on block size information and GPM information of the current block;
determining a blending width from the determined blending width set; and
reconstructing the current block according to the GPM and the determined blending width.

2. The method of claim 1, wherein the multiple blending width sets comprises a first blending width set {τ/4, τ/2, τ, 2τ, 4τ} and a second blending width set {τ/2, τ, 2τ, 4τ, 8τ}, and τ is positive.

3. The method of claim 1, wherein
the block size information indicates a block height and a block width of the current block, and the multiple blending width sets includes a first blending width set and a second blending width set; and
the determining the blending width set includes:
when the block width and the block height satisfy a first condition, determining the blending width set as the first blending width set;
when the block width and the block height satisfy a second condition, determining the blending width set as the second blending width set, the first condition and the second condition being based on a comparison between (i) both the block height and the block width and (ii) a threshold value T; and
when the block width and the block height do not satisfy the first condition and do not satisfy the second condition, determining the blending width set as one of the first blending width set and the second blending width set based on a partition mode in the GPM and an aspect ratio between the block height and the block width.

4. The method of claim 3, wherein
the block width and the block height do not satisfy the first condition and do not satisfy the second condition, and the aspect ratio is the block width over the block height;
two conditions include (i) the aspect ratio is larger than 1 and the partition mode in the GPM is a near vertical partition mode and (ii) the aspect ratio is smaller than 1 and the partition mode in the GPM is a near horizontal partition mode; and
the determining the blending width set as the one of the first blending width set and the second blending width set includes:
determining the blending width set as the second blending width set when one of the two conditions is satisfied; and
determining the blending width set as the first blending width set when none of the two conditions is satisfied.

5. The method of claim 4, wherein the partition mode in the GPM is the near horizontal partition mode when a geometric partition angle between a geometric split edge of the partition mode and a horizontal line is smaller than or equal to a predefined angle.

6. The method of claim 4, wherein the partition mode in the GPM is the near vertical partition mode when a geometric partition angle between a geometric split edge of the partition mode and a vertical line is smaller than or equal to a predefined angle.

7. The method of claim 1, wherein
the block size information indicates a block height and a block width of the current block, and the multiple blending width sets includes a first blending width set and a second blending width set;
a smallest blending width in the first blending width set is less than a smallest blending width in the second blending width set; and
the determining the blending width set includes:
determining the blending width set as the first blending width set when a third condition that each of the block height and the block width is smaller than or equal to a threshold value T1 is satisfied, and
determining the blending width set as the second blending width set when a fourth condition that each of the block height and the block width is larger than or equal to a threshold value T2 is satisfied, T2 being larger than T1; and
when the third condition is not satisfied and the fourth condition is not satisfied, determining the blending width set as one of the first blending width set and the second blending width set based on a partition mode in the GPM and an aspect ratio between the block height and the block width.

8. The method of claim 7, wherein
the third condition is not satisfied, the fourth condition is not satisfied, and the aspect ratio is the block width over the block height;
two conditions include i) the aspect ratio is larger than 1 and the partition mode in the GPM is a near vertical partition mode and ii) the aspect ratio is smaller than 1 and the partition mode in the GPM is a near horizontal partition mode; and
the determining the blending width set as the one of the first blending width set and the second blending width set includes:
determining the blending width set as the second blending width set when one of the two conditions is satisfied; and
determining the blending width set as the first blending width set when none of the two conditions is satisfied.

9. A method for video decoding, the method comprising:
receiving coded information indicating that a chroma block is coded based on a corresponding luma block using a cross-component prediction and a multi-model filter, the luma block being predicted by a geometric partition mode (GPM) and including a first partition and a second partition separated by a geometric split edge of the GPM;
determining the multi-model filter for the chroma block including a first partition and a second partition separated by a geometric split edge, the multi-model filter including one of (i) first filter coefficients determined based on the first partition of the luma block and the first partition of the chroma block and second filter coefficients determined based on the second partition of the luma block and the second partition of the chroma block and (ii) the first filter coefficients determined based on a first luma template of the luma block and a first chroma template of the chroma block and the second filter coefficients determined based on a second luma template of the luma block and a second chroma template of the chroma block, a luma template of the luma block being adjacent to the luma block and including reconstructed luma samples, the luma template including the first luma template and the second luma template separated by an extension of the geometric split edge into the luma template, a chroma template of the chroma block being adjacent to the chroma block and including reconstructed chroma samples, the chroma template including the first chroma template and the second chroma template separated by an extension of the geometric split edge into the chroma template; and
reconstructing the chroma block according to the multi-model filter.

10. The method of claim 9, wherein the determining the multi-model filter comprises:
determining the first filter coefficients of the multi-model filter based on the first luma template of the luma block and the first chroma template of the chroma block and determining the second filter coefficients of the multi-model filter based on the second luma template of the luma block and the second chroma template of the chroma block.

11. The method of claim 9, wherein the geometric split edge separating the chroma block is signaled or derived at the chroma block.

12. The method of claim 9, wherein the geometric split edge separating the chroma block is signaled or derived at the luma block when a single tree partition structure is used for the luma block and the chroma block.

13. The method of claim 9, wherein the multi-model filter is a linear filter.

14. The method of claim 9, wherein the multi-model filter is a non-linear polynomial filter.

15. The method of claim 9, wherein the reconstructing the chroma block comprises: applying the multi-model filter and the GPM to prediction samples or reconstructed samples of the luma block to reconstruct the chroma block.

16. The method of claim 9, wherein the determining the multi-model filter comprises:
determining the first filter coefficients of the multi-model filter based on first prediction luma samples in the first partition of the luma block and first prediction chroma samples in the first partition of the chroma block; and
determining the second filter coefficients of the multi-model filter based on second prediction luma samples in the second partition of the luma block and second prediction chroma samples in the second partition of the chroma block.

17. A method for video decoding, the method comprising:
receiving coded information indicating that a current block in a current picture is coded with an affine mode;
applying a template-matching process to determine a reference block in the current picture;
determining control point motion vectors (CPMVs) of the current block based on motion vector information associated with a plurality of corners of the reference block; and
reconstructing the current block based on the determined CPMVs of the current block.

18. The method of claim 17, further comprising:
scanning multiple blocks located at one of the plurality of corners of the reference block in a predefined scanning order to determine a motion vector associated with one of the multiple blocks, the motion information associated with the plurality of corners of the reference block including the determined motion vector associated with one of the one of the multiple blocks.

19. The method of claim 17, wherein
a block vector (BV) indicates the reference block from the current block;
the motion vector information associated with the plurality of corners of the reference block includes motion vectors associated with the plurality of corners; and
the determining the CPMVs of the current block includes determining the CPMVs of the current block as vector sums of the respective motion vectors associated with the plurality of corners and the BV.

20. The method of claim 17, wherein the reconstructing the current block comprises one of:
deriving an affine merge candidate used to construct an affine candidate list based on the CPMVs of the current block and reconstructing the current block based on one of affine merge candidates in the affine candidate list; or
deriving an affine motion vector predictor (MVP) of the current block and reconstructing the current block based on the affine MVP.
